(19) United States
(12) Patent Application Publication
(10) Pub. No.: US 2022/0179966 A1
(43) Pub. Date: Jun. 9, 2022

(54) INFORMATION PROCESSING DEVICE, INFORMATION PROCESSING METHOD, AND NON-TRANSITORY COMPUTER READABLE STORAGE MEDIUM

(71) Applicant: Kabushiki Kaisha Toshiba, Tokyo (JP)

(72) Inventors: Yurie SHINKE, Kawasaki (JP); Jun KANAI, Inagi (JP); Hideyuki MIYAKE, Kawasaki (JP)

(73) Assignee: Kabushiki Kaisha Toshiba, Tokyo (JP)

(21) Appl. No.: 17/451,680

(22) Filed: Oct. 21, 2021

(30) Foreign Application Priority Data
Dec. 4, 2020 (JP) 2020-202065

(51) Int. Cl. G06F 21/57; G06F 21/55; G06F 21/56

(52) U.S. Cl. CPC G06F 21/577; G06F 21/56; G06F 21/554; G06F 21/552

(57) ABSTRACT

According to one embodiment, an information processing device includes an influence information obtaining unit, a requirements information obtaining unit, and a ranking unit. The influence information obtaining unit obtains influence information indicating a correspondence between one or more security measures technologies and an influence on a system when each of the one or more security measures technologies is introduced into the system. The requirements information obtaining unit obtains common constraint condition information indicating system requirements of the system. The ranking unit classifies the one or more security measures technologies into a security measures technology satisfying a common constraint condition indicating the system requirements and a security measures technology not satisfying the common constraint condition, based on the common constraint condition information and the influence information, and ranks the security measures technology satisfying the common constraint condition.

### CROSS-REFERENCE TO RELATED APPLICATION

This application is based upon and claims the benefit of priority from Japanese Patent Application No. 2020-202065, filed on Dec. 4, 2020; the entire contents of which are incorporated herein by reference.

### FIELD

Embodiments of the present invention relate to an information processing device, an information processing method, and a non-transitory computer readable storage medium.

### BACKGROUND

In recent years, cyber-attacks targeting systems such as control systems and information systems have become common, and security measures are urgent issues. However, recent systems have various system configurations including a plurality of devices, and thus, an appropriate development period and cost are required to incorporate an optimal security measures for each system. For the purpose of shortening the development period and reducing the cost of security measures, a technology of automatically presenting a highly cost-effective security measures has been proposed.

Requirements that need to be satisfied in operating a system is referred to as system requirements. As the system requirements, for example, an “increase in communication delay” in a real-time system is not allowed in many cases. In addition, the system requirements may greatly vary depending on a target system. Therefore, it is required to design security measures in consideration of the system requirements of a target system.

### BRIEF DESCRIPTION OF THE DRAWINGS

FIG. 1 is a functional block diagram showing an example of a functional configuration of an information processing device according to a first embodiment.

FIG. 2 is a flowchart showing an example of processing executed by the information processing device according to the first embodiment.

FIG. 3 is a table showing an example of threat measures information.

FIG. 4 is a table showing an example of influence information.

FIG. 5 is a table showing an example of evaluation value information.

FIG. 6 is a table showing an example of requirements information.

FIG. 7 is a table showing an example of threat list information.

FIG. 8 is a table showing an example of threat-handling measures information.

FIG. 9 is a table showing an example of a security measures technology that satisfies a common constraint condition.

FIG. 10 is a table showing an example of a security measures technology not satisfying the common constraint condition.

FIGS. 11A to 11C are tables showing examples of calculation input information.

FIG. 12 is a table showing an example of a ranking result.

FIG. 13 is a table showing an example of the ranking result.

FIG. 14 is a table showing an example of the ranking result.

FIG. 15 is a table showing an example of measures technology set information related to Threat 1.

FIG. 16 is a table showing an example of the ranking result.

FIG. 17 is a table showing an example of the ranking result.

FIG. 18 is a table showing an example of the ranking result.

FIG. 19 is a table showing an example of measures technology set information related to Threat 2.

FIG. 20 is a functional block diagram showing an example of a functional configuration of an information processing device according to a second embodiment.

FIG. 21 is a flowchart showing an example of processing executed by the information processing device according to the second embodiment.

FIG. 22 is a table showing an example in which each ranking of the ranking result is replaced with a score.

FIG. 23 is a table showing an example of a final ranking result.

FIG. 24 is a table showing an example of measures technology set information according to the second embodiment.

FIG. 25 is a functional block diagram showing an example of a functional configuration of an information processing device according to a third embodiment.

FIG. 26 is a flowchart showing an example of processing executed by the information processing device according to the third embodiment.

FIG. 27 is a table showing an example of threat measures information according to the third embodiment.

FIG. 28 is a table showing an example of combination information.

FIG. 29 is a table showing an example of threat-handling measures information according to the third embodiment.

FIG. 30 is a table showing an example of influence information according to the third embodiment.

FIG. 31 is a table showing an example of evaluation value information according to the third embodiment.

FIG. 32 is a table showing an example of a security measures technology that satisfies a common constraint condition.

FIG. 33 is a table showing an example of calculation input information according to the third embodiment.

FIG. 34 is a table showing an example of the calculation input information according to the third embodiment.

FIG. 35 is a table showing an example of the calculation input information according to the third embodiment.

FIG. 36 is a table showing an example of a ranking result.

FIG. 37 is a table showing an example of the ranking result.

FIG. 38 is a table showing an example of the ranking result.

FIG. 39 is a diagram showing an example of a hardware configuration of the information processing device according to the embodiments.

### DETAILED DESCRIPTION

According to one embodiment, an information processing device includes an influence information obtaining unit, a requirements information obtaining unit, and a ranking unit. The influence information obtaining unit obtains influence information indicating a correspondence between one or more security measures technologies and an influence on a system when each of the one or more security measures technologies is introduced into the system. The requirements information obtaining unit obtains common constraint condition information indicating system requirements of the system. The ranking unit classifies the one or more security measures technologies into a security measures technology satisfying a common constraint condition indicating the system requirements and a security measures technology not satisfying the common constraint condition, based on the common constraint condition information and the influence information, and ranks the security measures technology satisfying the common constraint condition.

### First Embodiment

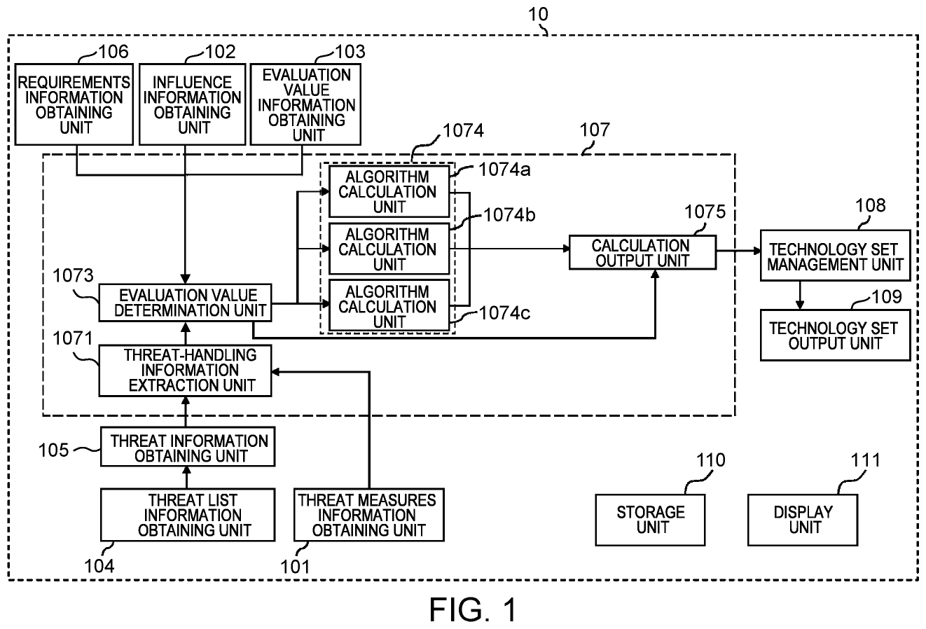

FIG. 1 is a functional block diagram showing an example of a functional configuration of an information processing device 10 according to a first embodiment.

The information processing device 10 is an apparatus that supports user's security design. Specifically, the information processing device 10 ranks one or more security measures technologies that are effective against (capable of coping with) a threat in a system for which security measures are designed, and further presents the security measures technologies to a user. The user can easily perform the security design by recognizing security measures technologies which are highly effective when being introduced and by selecting a security measures technology from the security measures technologies.

Note that the security measures technology is sometimes simply referred to as a measures technology in the specification. In addition, a system to which security measures are introduced is sometimes simply referred to as a target system in the specification.

The information processing device 10 ranks one or more security measures technologies satisfying a constraint condition, based on an evaluation value of the security measures technology with at least system requirements as the constraint condition. The information processing device 10 outputs the ranking result, thereby supporting selection determination of the security measures technology by the user who selects the security measures technology.

As an example, a case of presenting a recommended security measures technology when a constraint condition in a target system is security requirements and system requirements will be described hereinafter.

Here, the security requirements are a condition for security characteristics of the security measures technology to be introduced into the target system in the specification. For example, functions (prevention, inhibition, detection, and recovery) of the security measures technology are an example of the security characteristics of the security measures technology.

In addition, the system requirements are a condition of a function that needs to be satisfied by the system in operating the system in the specification.

For example, an “increase in communication delay” in a real-time system is not allowed in many cases. In this case, a condition that the “increase in communication delay” is not allowed may be the system requirements. Note that security requirements information indicating the security requirements and system requirements information indicating the system requirements are sometimes collectively referred to as requirements information in the specification.

As shown in FIG. 1, the information processing device 10 includes a threat measures information obtaining unit 101, an influence information obtaining unit 102, an evaluation value information obtaining unit 103, a threat list information obtaining unit 104, a threat information obtaining unit 105, a requirements information obtaining unit 106, a ranking unit 107, a technology set management unit 108, a technology set output unit 109, a storage unit 110, and a display unit 111.

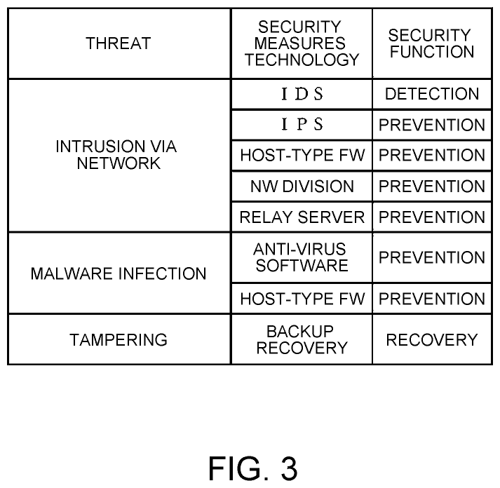

The threat measures information obtaining unit 101 has a function of obtaining information (which will be sometimes referred to as threat measures information hereinafter) indicating a correspondence between a threat and a security measures technology effective against the threat from the storage unit 110, and managing the obtained information in, for example, a table format shown in FIG. 3. The threat measures information obtaining unit 101 outputs the threat measures information to a threat-handling information extraction unit 1071. The threat measures information further has information indicating a correspondence between a security measures technology and a security characteristic of the security measures technology (information indicating the security characteristic of the security measures technology). FIG. 3 will be described separately.

In a case where the information processing device 10 considers the security requirements as a common constraint condition, the threat measures information needs to include information indicating security characteristics of the respective security measures technologies. Note that the threat measures information is information described in catalogs of general-purpose security measures technologies or databases of the security measures technologies.

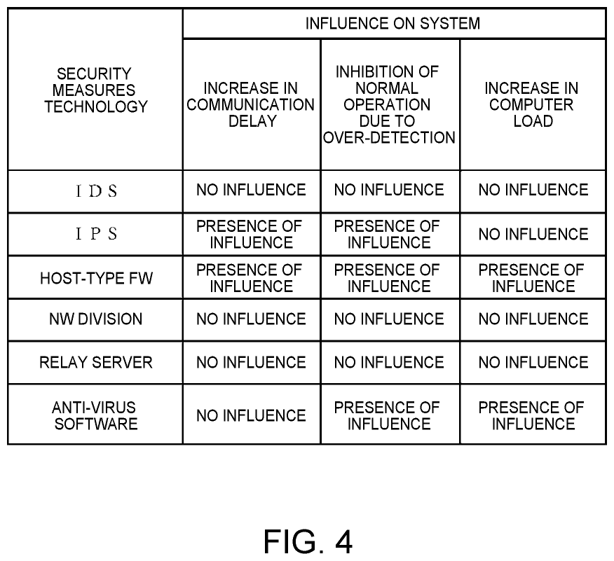

The influence information obtaining unit 102 has a function of obtaining information (which will be sometimes simply referred to as influence information hereinafter) which indicates a correspondence between a security measures technology and an “influence on system” generated when the security measures technology is introduced into the target system from the storage unit 110, and managing the information in, for example, a table format shown in FIG. 4. The influence information obtaining unit 102 outputs the obtained influence information to the evaluation value determination unit 1073. The influence information is an “influence on system” generated when a security measures technology is introduced into the system.

Here, the “influence on system” refers to an influence that hinders a function expected by a target system in operating the target system. Examples thereof include the “increase in communication delay” and the like. Note that the influence information is information described in catalogs of general-purpose security measures technologies or databases of the security measures technologies.

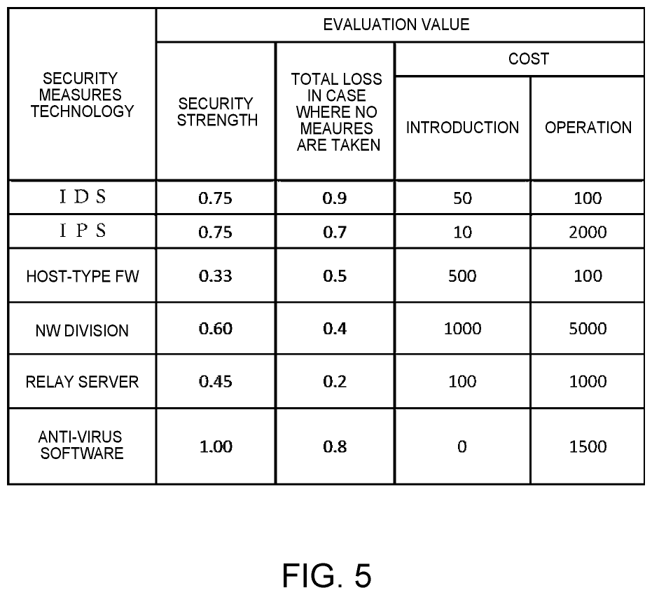

The evaluation value information obtaining unit 103 has a function of obtaining information (which will be sometimes referred to as evaluation value information hereinafter) which indicates a correspondence between a security measures technology and an evaluation value of the security measures technology from the storage unit 110, and managing the obtained information in, for example, a table format shown in FIG. 5. Here, the evaluation value is an eigenvalue of a security measures technology used when an algorithm calculation unit 1074 ranks the security measures technology. Examples of the evaluation value include a security strength, a total loss in a case where no measures are taken, an introduction cost, an operation cost, and the like.

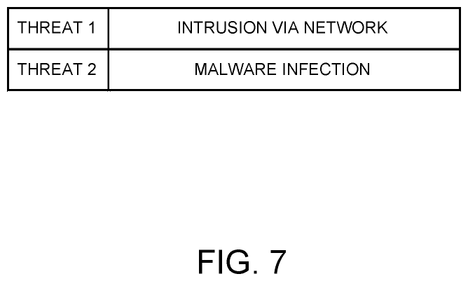

The threat list information obtaining unit 104 has a function of obtaining information (also referred to as threat list information) indicating a threat list in a target system by the user's input, and managing the information in, for example, a table format shown in FIG. 7.

The threat information obtaining unit 105 obtains information indicating one threat (also referred to as threat information) from threats included in the threat list information managed by the threat list information obtaining unit 104, and outputs the obtained information to the threat-handling information extraction unit 1071.

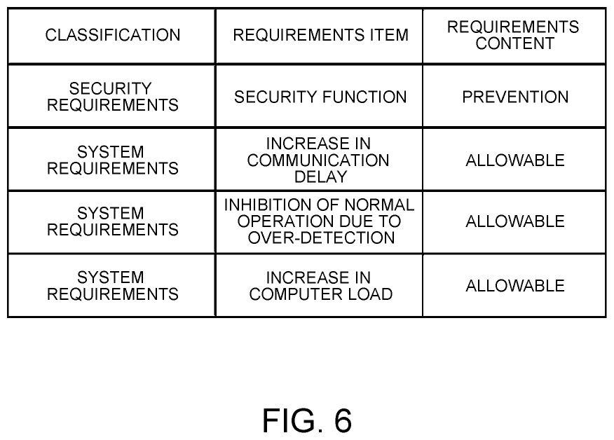

The requirements information obtaining unit (also referred to as a common constraint condition information obtaining unit or a constraint condition information obtaining unit) 106 obtains requirements information (also referred to as common constraint condition information or constraint condition information) indicating a requirement for a security design of the target system by the user's input, and manages the requirements information in, for example, a table format shown in FIG. 6.

The constraint condition information includes at least system requirements. In the present embodiment, the constraint condition information includes system requirements and security requirements.

The ranking unit 107 includes the threat-handling information extraction unit 1071, an evaluation value determination unit 1073, algorithm calculation units 1074a, 1074b and 1074c, and a calculation output unit 1075. The ranking unit 107 ranks a security measures technology to be ranked, based on an evaluation value associated with the security measures technology.

The threat-handling information extraction unit 1071 obtains the threat measures information from the threat measures information obtaining unit 101 and obtains the threat information from the threat information obtaining unit 105. The threat-handling information extraction unit 1071 extracts threat-handling measures information, based on the threat measures information and the threat information.

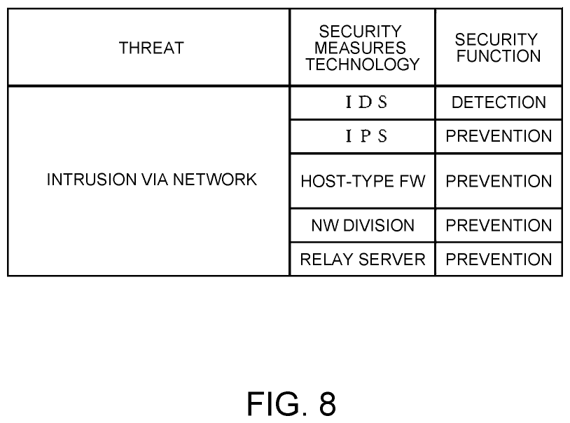

FIG. 8 is a table showing an example of the threat-handling measures information. In the specification, the threat-handling measures information is information in which a threat obtained from the threat information obtaining unit 105, a security measures technology effective against the threat, and a security characteristic of the security measures technology, are associated with each other.

The threat-handling information extraction unit 1071 outputs the extracted threat-handling measures information to the evaluation value determination unit 1073.

The evaluation value determination unit 1073 obtains the threat-handling measures information from the threat-handling information extraction unit 1071, obtains the influence information from the influence information obtaining unit 102, obtains the evaluation value information from the evaluation value information obtaining unit 103, and obtains the requirements information from the requirements information obtaining unit 106.

The evaluation value determination unit 1073 extracts a list of security measures technologies satisfying the requirements information, based on the requirement information, the threat-handling measures information and the influence information. The security measures technologies satisfying the requirements information are subjected to evaluation in the algorithm calculation unit 1074 to be described later.

The evaluation value determination unit 1073 refers to the evaluation value information and extracts evaluation values of the extracted security measures technologies.

The evaluation value determination unit 1073 outputs a list of security measures technologies (satisfying the common constraint condition) and evaluation values of the security measures technologies (to be used for each calculation process) as calculation input information (also referred to as calculation input values) to the algorithm calculation units 1074a, 1074b, and 1074c.

In addition, the evaluation value determination unit 1073 outputs information indicating a list of security measures technologies not satisfying the common constraint condition to the calculation output unit 1075.

The algorithm calculation unit (also referred to as a calculation unit) 1074 obtains the list of security measures technologies (satisfying the common constraint condition) and the evaluation values from the evaluation value determination unit 1073, and performs calculation based on the evaluation values.

In the present embodiment, the algorithm calculation unit (also referred to as a calculation unit) 1074 includes three algorithm calculation units 1074a, 1074b, and 1074c, but at least one algorithm calculation unit may be provided.

Note that the algorithm described in the present embodiment is merely an example, and can be replaced with any objective function that is considered to be necessary for selection of security measures.

The algorithm calculation unit 1074a uses the security strength as the evaluation value, and ranks the security measures technologies such that a security measures technology with a high security strength is recommended.

The algorithm calculation unit 1074b uses the total loss in the case where no measures are taken as the evaluation value, and ranks the security measures technologies such that a security measures technology having a large total loss in the case where no measures are taken is recommended.

Here, the total loss in the case where no measures are taken is a value comprehensively determined, based on a repair time, a failure interval, and a loss caused by a failure of a threat, in a case where the failure occurs with respect to the threat generated since no security measures technology is implemented.

The algorithm calculation unit 1074c uses the introduction cost and the operation cost as the evaluation values, and ranks the security measures technologies such that a security measures technology with a small cost is recommended. Here, the introduction cost is an amount of money required for introduction of security measures, and the operation cost is an amount of money required for operation of a security measures technology. As an example, the cost can be expressed by the sum of the introduction cost and the operation cost.

The algorithm calculation units 1074a, 1074b and 1074c output ranking results to the calculation output unit 1075.

Note that there may be one security measures technology to be ranked. In a case where there is one security measures technology to be ranked, this security measures technology is ranked as the first.

The calculation output unit 1075 obtains the ranking results from the algorithm calculation units 1074a, 1074b and 1074c. In addition, in a case where there are security measures technologies not satisfying the constraint condition, the calculation output unit 1075 obtains information indicating a list of the security measures technologies from the evaluation value determination unit 1073. The calculation output unit 1075 generates measures technology set information, based on the ranking results obtained from the algorithm calculation units 1074a, 1074b and 1074c, and the information indicating the list of security measures technologies not satisfying the constraint condition obtained from the evaluation value determination unit 1073.

Here, the measures technology set information (also referred to as technology set information) includes information in which a threat, a security measures technology not satisfying the constraint condition among security measures technologies effective against the threat, and a ranking result of security measures technologies satisfying the constraint condition among the security measures technologies effective against the threat, are associated with each other.

The calculation output unit 1075 outputs the generated measures technology set to the technology set management unit 108.

The technology set management unit 108 manages one or a plurality of pieces of measures technology set information. The measures technology set information may include information indicating a score used for ranking. In a case where the number of threats in a target system is only one (the number of threats indicated by the threat list information is one), the technology set management unit 108 provides the technology set output unit 109 with measures technology set information related to this threat.

In a case where the number of threats in the target system is plural (the number of threats indicated by the threat list information is plural), the ranking unit 107 ranks security measures technologies effective against each of the threats included in the threat list information for the target system.

Specifically, if the ranking of security measures technologies effective against a first treat included in the threat list information is performed and the measures technology set information is transmitted to the technology set management unit 108, the threat information obtaining unit 105 obtains threat information indicating a second threat from the threat list information and transmits the obtained threat information to the ranking unit 107.

The ranking unit 107 ranks security measures technologies effective against the second threat by the method described above. The above processing is executed for all the threats in the threat list information. Then, when measures technology sets for all the threats is prepared, the technology set management unit 108 outputs the measures technology set information to the technology set output unit 109.

The technology set output unit 109 outputs the measures technology set information. As an example, the technology set output unit 109 outputs the measures technology set information to the display unit 111.

The display unit 111 displays the measures technology set information received from the technology set output 109. Note that the display unit 111 is provided inside the information processing device 10 herein, but may be provided outside the information processing device 10.

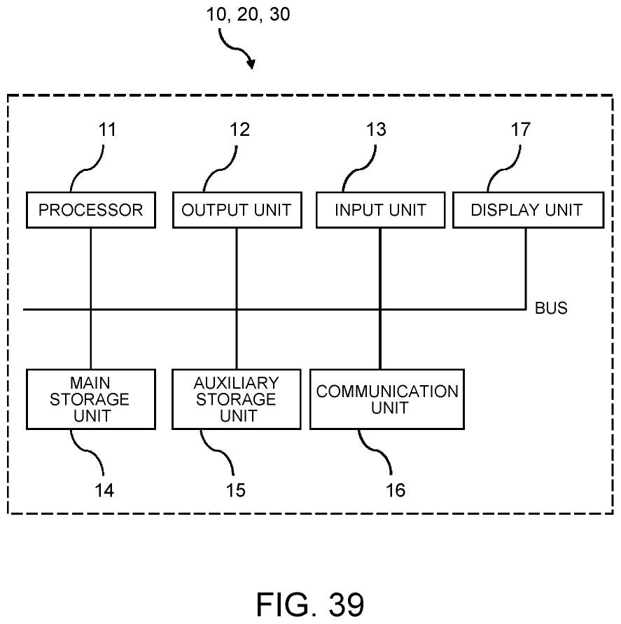

The storage unit 110 stores various types of information to be used by the information processing device 10 according to the embodiment. The storage unit 110 can be realized by an auxiliary storage unit 15 (FIG. 39) such as a hard disk drive (HDD).

Next, FIGS. 3 to 11 will be described.

FIG. 3 shows an example of the threat measures information managed by the threat measures information obtaining unit 101. Examples of the threats include “intrusion via network”, “malware infection”, “tampering”, and the like. A security measures technology is a coping technique effective against the threat.

FIG. 3 shows that an “intrusion detection system (IDS)”, an “intrusion prevention system (IPS)”, a “host-type fire wall (FW)”, a “network (NW) division”, and a “relay server” are present as security measures technologies effective against the threat of “intrusion via network”.

In addition, it is shown that “anti-virus software” and “host-type FW” are present as security measures technologies against the threat of “malware infection”. Here, the “host-type FW” is FW installed in a host computer among FW.

In addition, it is shown that there is “backup recovery” as a security measures technology against the threat of “tampering”.

Note that information indicating a correspondence between a security measures technology and a characteristic of the security measures technology in terms of security (also referred to as the security characteristic) may be added to the threat measures information as shown in FIG. 3.

Here, the security characteristic refers to overall characteristics of a security measures technology, such as a function of the security measures technology (sometimes simply referred to as a security function), the strength of the security measures technology, and ease of operation of the security measures technology. Note that the security characteristic is also information indicating a degree of satisfaction of security requirements.

Security measures technologies can be classified into a technology such as the “IPS” having a function of “prevention” of an attack, a technology such as the “IDS” having a function of “detection” of an attack, and a technology such as backup recovery having a function of “recovery” from an abnormal state caused by an attack. The above-described “prevention”, “detection” and “recovery” are specific examples of the security function. FIG. 3 shows information indicating the security function as the information indicating the security characteristic.

FIG. 4 shows an example of the influence information managed by the influence information obtaining unit 102. Specific examples of the “influence on system” include “increase in communication delay”, “inhibition of a normal operation due to over-detection” and “increase in computer load”.

The example of FIG. 4 shows that “IDS” has no particular “influence on system”. It is shown that “IPS” has an influence on “increase in communication delay” and “inhibition of normal operation due to over-detection” as “influence on system”. It is shown that “host-type FW” has an influence on any of “increase in communication delay”, “inhibition of normal operation due to over-detection” and “increase in computer load”. It is shown that “NW division” has no particular “influence on system”. It is shown that “relay server” has no particular “influence on system”. It is shown that “anti-virus software” has an influence on “inhibition of normal operation due to over-detection” and “increase in computer load” as “influence on system”.

Note that the presence or absence of “influence on system” is description information herein, but the “influence on system” may be described in multiple stages such as “no influence”, “large influence”, “medium influence” and “small influence”. In addition, a specific value (for example, X [ms] and the like) may be described in a case where the “influence on system” is quantified (for example, in a case where an increase amount of a communication delay is quantified). Note that the “influence on system” is also information indicating a degree of satisfaction of system requirements. For example, when a requirement that the “increase in communication delay” is not allowed is present as the system requirements, it is not desirable to introduce the security measures technology that has the “influence on system”, because it is difficult to satisfy the system requirements.

FIG. 5 shows an example of the evaluation value information managed by the evaluation value information obtaining unit 103. In FIG. 5, the security strength, the total loss in the case where no measures are taken, and the cost (the introduction cost and the operation cost) as the evaluation values are associated with each security measures technology.

The example of FIG. 5 shows that the security strength of “IDS” is “0.75”, the total loss in the case where no measures are taken is “0.9”, the introduction cost is “50”, and the operation cost is “100”.

FIG. 6 shows an example of the requirements information obtained by the requirements information obtaining unit 106. The requirements information (also referred to as common constraint condition information) is information indicating security requirements (security requirements information) or information indicating system requirements (system requirements information). As shown in FIG. 6, the requirements information is information in which “classification” indicating whether the requirement is the security requirements or the system requirements, a “requirements item”, and a “requirements content” are associated with each other.

FIG. 6 shows that, as the security requirements, “requirements item” is designated as “security function”, and “requirements content” corresponding to “security function” is designated as “prevention”. In addition, FIG. 6 shows that, as the system requirements, “requirements items” are designated as “increase in communication delay”, “inhibition of normal operation due to over-detection” and “increase in computer load”, and “requirements contents” corresponding to these “requirements items” are designated as “allowable” “allowable” and “allowable” in order.

Note that the requirements content is described by the presence or absence of the system requirements (unallowable or allowable) in FIG. 6, but may be described in proportion to the magnitude (strength) of the system requirements (magnitude of constraint), as “large requirement (large constraint)”, “medium requirement (medium constraint)”, “small requirement (small constraint)”, “no requirements (no constraints)”, or an allowable specific value (for example, in the case of communication delay, X [ms] or less is allowable, and X [ms] or more is unallowable). In addition, items for inputting the magnitude (strength) of the security requirements such as “large requirement”, “medium requirement” and “small requirement” may be provided similarly for the security requirements.

In the first embodiment, it is assumed that the requirements information obtaining unit 106 obtains the requirements information by the user's inputting (with recognition) the classification of the security requirements and the system requirements. The requirements information obtaining unit 106 may classify the “requirements item” input by the user into the security requirements or the system requirements by referring to an existing database that manages “requirements item” in association with the security requirements and the system requirements.

FIG. 7 is a table showing an example of the threat list information. The threat list information is information indicating a list of threats in a target system, for example, Threat 1: “intrusion via network”, Threat 2: “malware infection”, and the like. The threat list information may be input by utilizing a general risk assessment method, or an output of a result using a tool.

FIG. 8 is a table showing an example of the threat-handling measures information related to Threat 1. In FIG. 8, Threat 1 of “intrusion via network”, a security measures technology capable of coping with Threat 1, and a security function of the security measures technology are associated with each other.

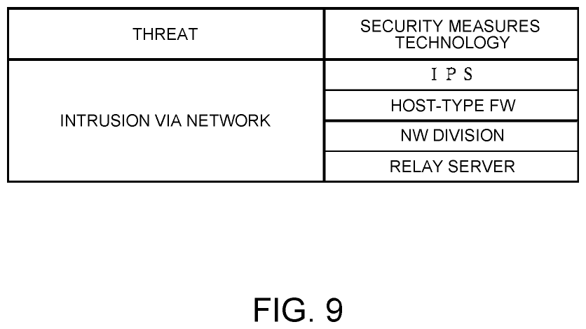

FIG. 9 shows an example of security measures technologies satisfying the common constraint condition among security measures technologies capable of coping with Threat 1.

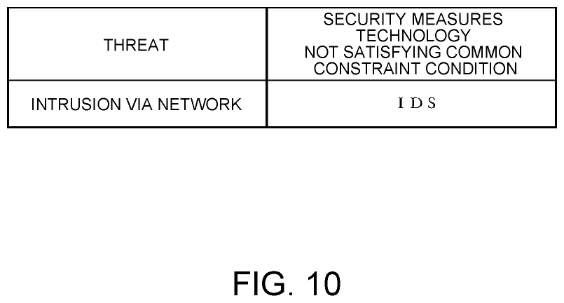

FIG. 10 shows an example of a security measures technology not satisfying the common constraint condition among the security measures technologies capable of coping with Threat 1. In FIG. 10, the “IDS” is shown as the security measures technology not satisfying the common constraint condition among the security measures technologies capable of coping with Threat 1.

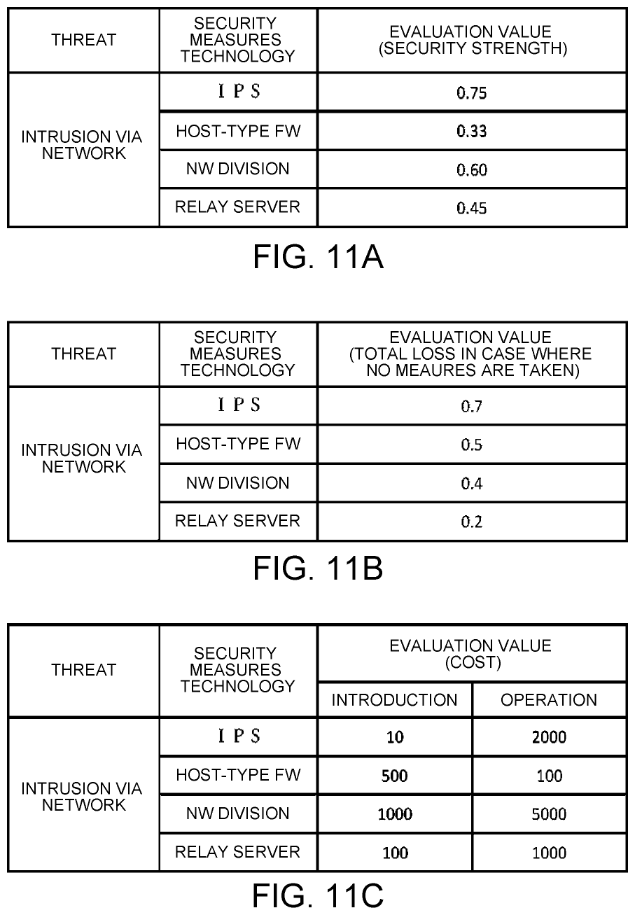

FIGS. 11A to 11C are tables showing examples of the calculation input information.

FIG. 11A shows an example of calculation input information input to the algorithm calculation unit 1074a. In FIG. 11A, the security measures technology satisfying the common constraint condition is associated with the security strength (an example of the evaluation value).

FIG. 11B shows an example of calculation input information input to the algorithm calculation unit 1074b. In FIG. 11B, the security measures technology satisfying the common constraint condition is associated with the total loss in the case where no measures are taken (an example of the evaluation value).

FIG. 11C shows an example of calculation input information input to the algorithm calculation unit 1074c. In FIG. 11C, the security measures technology satisfying the common constraint condition is associated with the cost (an example of the evaluation value). Here, the cost is shown as the introduction cost and the operation cost in FIG. 11C.

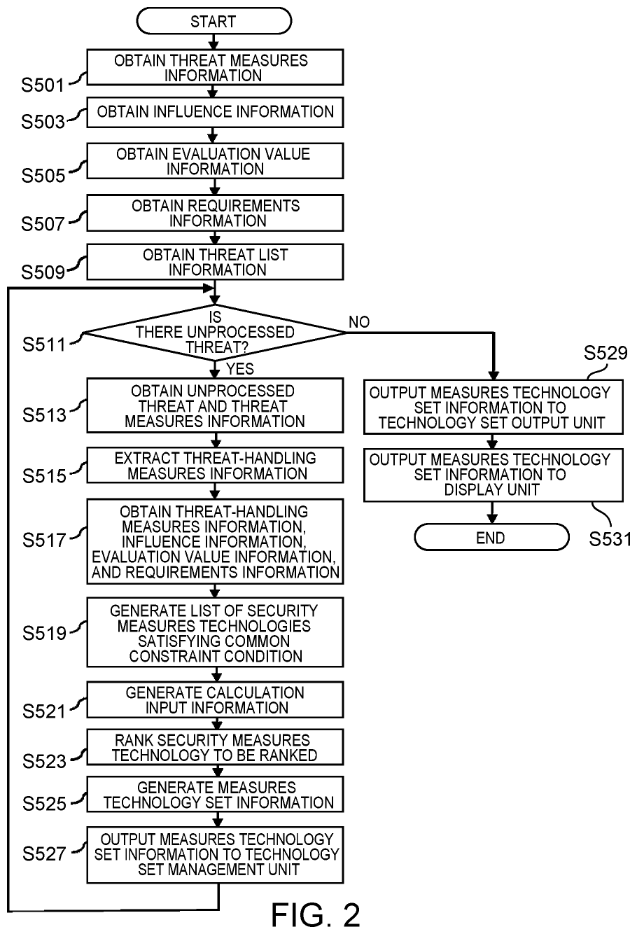

FIG. 2 is a flowchart showing an example of processing executed by the information processing device 10 according to the first embodiment.

In step S501 of FIG. 2, the threat measures information obtaining unit 101 obtains threat measures information from the storage unit 110.

In step S503 of FIG. 2, the influence information obtaining unit 102 obtains influence information from the storage unit 110.

In step S505 of FIG. 2, the evaluation value information obtaining unit 103 obtains evaluation value information from the storage unit 110.

In step S507 of FIG. 2, the requirements information obtaining unit 106 obtains requirements information by the user's input.

In step S509 of FIG. 2, the threat list information obtaining unit 104 obtains threat list information in a target system by the user's input, and manages the obtained threat list information in, for example, a table format shown in FIG. 7.

In step S511 of FIG. 2, the threat information obtaining unit 105 determines whether there is an unprocessed threat in the threat list information managed by the threat list information obtaining unit 104.

When the threat information obtaining unit 105 determines that there is an unprocessed threat in the threat list information (step S511: YES), the threat information obtaining unit 105 obtains threat information indicating one unprocessed threat from the threat list information, and outputs the obtained threat information to the threat-handling information extraction unit 1071. The threat-handling information extraction unit 1071 obtains the threat information (step S513). Here, it is assumed that Threat 1 of “intrusion via network” in FIG. 7 is obtained as the threat information. Similarly, the threat-handling information extraction unit 1071 obtains the threat measures information shown in FIG. 3 from the threat measures information obtaining unit 101 in step S507.

The threat-handling information extraction unit 1071 extracts threat-handling measures information related to Threat 1 (information indicating a security measures technology effective against Threat 1 and information indicating a security characteristic of the security measures technology) based on the threat information and the threat measures information (step S515).

The evaluation value determination unit 1073 obtains the threat-handling measures information related to Threat 1 (FIG. 8) from the threat-handling information extraction unit 1071, obtains the influence information (FIG. 4) from the influence information obtaining unit 102, obtains the evaluation value information (FIG. 5) from the evaluation value information obtaining unit 103, and obtains the requirements information (FIG. 6) from the requirements information obtaining unit 106 (step S517).

The evaluation value determination unit 1073 generates a list of security measures technologies satisfying the common constraint conditions (FIG. 9) among the security measures technologies capable of coping with Threat 1, based on the threat-handling measures information, the influence information and the requirements information (common constraint condition information) related to Threat 1 (step S519). Here, the security measures technology capable of coping with Threat 1 is the security measures technology indicated in the threat-handling measures information (FIG. 8) related to Threat 1.

The evaluation value determination unit 1073 uses the threat-handling measures information to determine whether the common constraint condition related to the security requirements is satisfied or not satisfied among the common constraint conditions. In addition, the evaluation value determination unit 1073 uses the influence information to determine whether the common constraint condition related to the system requirements is satisfied or not satisfied among the common constraint conditions.

First, a method for determining whether the common constraint condition related to the security requirements is satisfied or not satisfied will be described. In the present embodiment, the common constraint condition related to the security requirements is that the “security function” is “prevention” as shown in FIG. 6. In the threat-handling measures information related to Threat 1 shown in FIG. 8, the security function of the “IDS” is “detection”. In addition, the security functions of the “IPS”, the “host-type FW”, the “NW division”, and the “relay server” are “prevention” in FIG. 8.

Therefore, only the “IDS” does not satisfy the common constraint condition related to the security requirements, and the “IPS”, the “host-type FW”, the “NW division” and the “relay server” satisfy the common constraint condition related to the security requirements.

Next, a method for determining whether the common constraint condition related to the system requirements is satisfied or not satisfied will be described.

In FIG. 6, all of the “increase in communication delay”, the “inhibition of normal operation due to over-detection”, and the “increase in computer load” are set to “allowable” as the common constraint condition related to the system requirements. In this case, even when there is a security measures technology that has an influence on any one of the “increase in communication delay”, the “inhibition of normal operation due to over-detection”, and the “increase in computer load” in the influence information among the security measures technologies capable of coping with Threat 1, the security measures technology also satisfies the common constraint condition related to the system requirements.

Therefore, all the security measures technologies capable of coping with Threat 1 satisfy the common constraint condition related to the system requirements.

As described above, the security measures technologies satisfying the common constraint condition are the “IPS”, the “host-type FW”, the “NW division”, and the “relay server”. In addition, the security measures technology not satisfying the common constraint condition is the “IDS”.

As described above, FIG. 9 is an example of a list of the security measures technologies satisfying the common constraint condition among the security measures technologies capable of coping with Threat 1. In FIG. 9, the “IPS”, the “host-type FW”, the “NW division”, and the “relay server” are shown as the security measures technologies satisfying the common constraint condition among the security measures technologies capable of coping with Threat 1.

Note that the requirements content is “allowable” for all requirements items of the system requirements in the above example. On the other hand, in a case where there is a requirements item whose requirements content is “unallowable” in the system requirements as the common constraint condition, a security measures technology that does not satisfy the requirements item is the security measures technology not satisfying the common constraint condition.

As an example, a case where the requirements item of the “increase in communication delay” of the system requirements is “unallowable” is considered as the common constraint condition. In this case, a security measures technology in which the “increase in communication delay” is “presence of influence” in the influence information is the security measures technology not satisfying the common constraint condition.

In addition, in a case where there is a security measures technology not satisfying the common constraint condition, the evaluation value determination unit 1073 generates the list of the security measures technologies (FIG. 10) similarly in step S519.

In step S521 of FIG. 2, the evaluation value determination unit 1073 generates the calculation input information (FIGS. 11A to 11C) based on the list of security measures technologies satisfying the common constraint condition and the evaluation value information.

The calculation input information is information which is used when the algorithm calculation unit 1074 ranks the security measures technology and in which the security measures technology satisfying the common constraint condition (the security measures technology to be ranked) is associated with the evaluation value.

The evaluation value determination unit 1073 generates the calculation input information by extracting the evaluation value associated with the security measures technology satisfying the common constraint condition from the evaluation value information (FIG. 5).

The evaluation value determination unit 1073 generates the calculation input information to be used by each of the algorithm calculation units 1074a, 1074b, and 1074c.

The evaluation value determination unit 1073 outputs the calculation input information to the algorithm calculation units 1074a, 1074b, and 1074c similarly in step S521. Specifically, the evaluation value determination unit 1073 outputs the calculation input information shown in FIG. 11A to the algorithm calculation unit 1074a, outputs the calculation input information shown in FIG. 11B to the algorithm calculation unit 1074b, and outputs the calculation input information shown in FIG. 11C to the algorithm calculation unit 1074c.

The algorithm calculation units 1074a, 1074b, and 1074c obtain the calculation input information.

In addition, the evaluation value determination unit 1073 outputs the list (FIG. 10) of security measures technologies not satisfying the common constraint condition to the calculation output unit 1075 similarly in step S521.

In step S523, the algorithm calculation unit 1074 ranks the security measures technologies (to be ranked) based on the calculation input information.

The algorithm calculation unit 1074a ranks the security measures technologies (to be ranked) by using the security strength as the evaluation value.

The algorithm calculation unit 1074a performs ranking in descending order of the security strength, based on the evaluation value associated with each of the security measures technologies. Referring to FIG. 11A, the security strength of the “IPS” is “0.75”, the security strength of the “host-type FW” is “0.33”, the security strength of the “NW division” is “0.60”, and the security strength of the “relay server” is “0.45”. Therefore, when the ranking is performed in descending order of the security strength, the “IPS” becomes the first place, the “NW division” becomes the second place, the “relay server” becomes the third place, and the “host-type FW” becomes the fourth place.

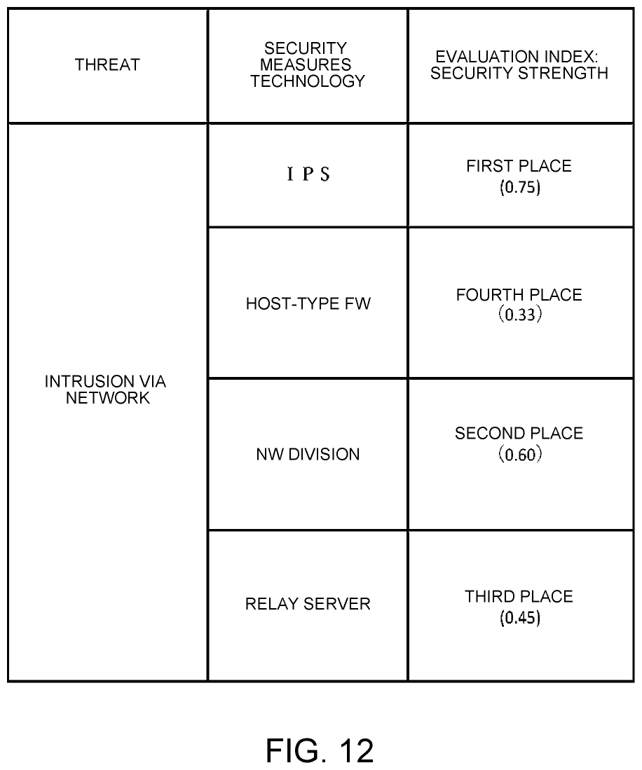

The above result is shown in FIG. 12. FIG. 12 is a table showing an example of the ranking result of the algorithm calculation unit 1074a. As an example, the algorithm calculation unit 1074a generates the ranking result shown in FIG. 12.

In FIG. 12, a security measures technology that is effective against Threat 1 and satisfies the common constraint condition, the ranking result by the algorithm calculation unit 1074a, and a score using the security strength as an evaluation index, are associated.

The algorithm calculation unit 1074b performs ranking in descending order of the total loss in a case where no measures are taken, based on the evaluation value of “the total loss in the case where no measures are taken” associated with each security measures technology. Referring to FIG. 11B, a total loss in a case where the measures of “IPS” are not taken is “0.7”, a total loss in a case where the measures of “host-type FW” are not taken is “0.5”, a total loss in a case where the measures of “NW division” are not taken is “0.4”, and a total loss in a case where the measures of “relay server” are not taken is “0.2”.

Therefore, when the ranking is performed in descending order of the total loss in the case where no measures are taken, the “IPS” becomes the first place, the “host-type FW” becomes the second place, the “NW division” becomes the third place, and the “relay server” becomes the fourth place.

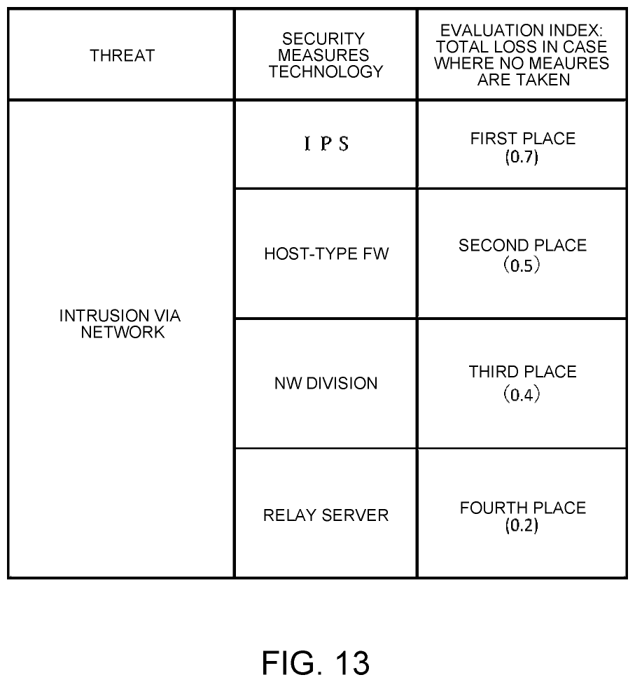

The above result is shown in FIG. 13. FIG. 13 is a table showing an example of the ranking result of the algorithm calculation unit 1074b. As an example, the algorithm calculation unit 1074b generates the ranking result shown in FIG. 13. In FIG. 13, a security measures technology that is effective against Threat 1 and satisfies the common constraint condition, the ranking result by the algorithm calculation unit 1074b, and a score using the total loss in the case where no measures are taken as an evaluation index, are associated.

The algorithm calculation unit 1074c performs ranking in ascending order of the total cost, based on the sum (total cost) of the introduction cost and the operation cost using the evaluation value of “introduction cost and operation cost” associated with each security measures technology. Referring to FIG. 11C, the introduction cost of the “IPS” is “10”, and the operation cost thereof is “2000”. In addition, the introduction cost of the “host-type FW” is “500”, and the operation cost thereof is “100”. In addition, the introduction cost of the “NW division” is “1000”, and the operation cost thereof is “5000”. In addition, the introduction cost of the “relay server” is “100”, and the operation cost thereof is “1000”.

Note that the operation cost is, for example, a cost required for ten years in a case where it is assumed that a security measures technology is implemented in a target system for ten years in the present embodiment.

Therefore, the total cost of the IPS is 10+2000=2010.

The total cost of the host-type FW is 500+100=600.

The total cost of the NW division is 1000+5000=6000.

The total cost of the relay server is 100+1000=1100.

Therefore, when the ranking is performed in ascending order of the total cost, the “host-type FW” becomes the first place, the “relay server” becomes the second place, the “IPS” becomes the third place, and the “NW division” becomes the fourth place.

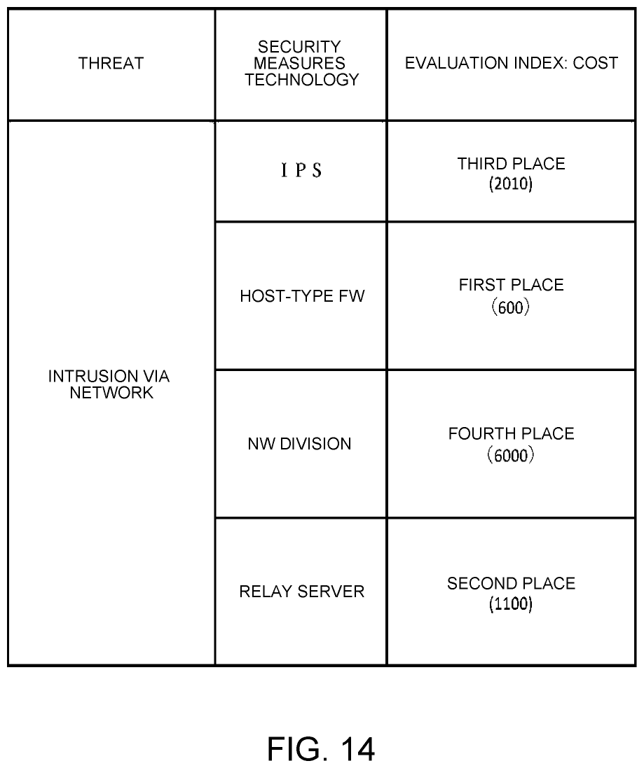

The above result is shown in FIG. 14. FIG. 14 is a table showing an example of the ranking result of the algorithm calculation unit 1074c. As an example, the algorithm calculation unit 1074c generates the ranking result shown in FIG. 14. In FIG. 14, a security measures technology that is effective against Threat 1 and satisfies the common constraint condition, the ranking result by the algorithm calculation unit 1074C, and a score using the cost as an evaluation index, are associated.

In step S523 of FIG. 2, the algorithm calculation units 1074a, 1074b, and 1074c further output the ranking results to the calculation output unit 1075.

In step S525, the calculation output unit 1075 obtains the list (FIG. 10) of security measures technologies not satisfying the common constraint condition from the evaluation value determination unit 1073, and obtains the ranking results (FIGS. 12 to 14) from the algorithm calculation unit 1074 (1074a, 1074b, and 1074c).

Further, in step S525, the calculation output unit 1075 generates measures technology set information, based on the list of security measures technologies not satisfying the common constraint condition and the ranking results.

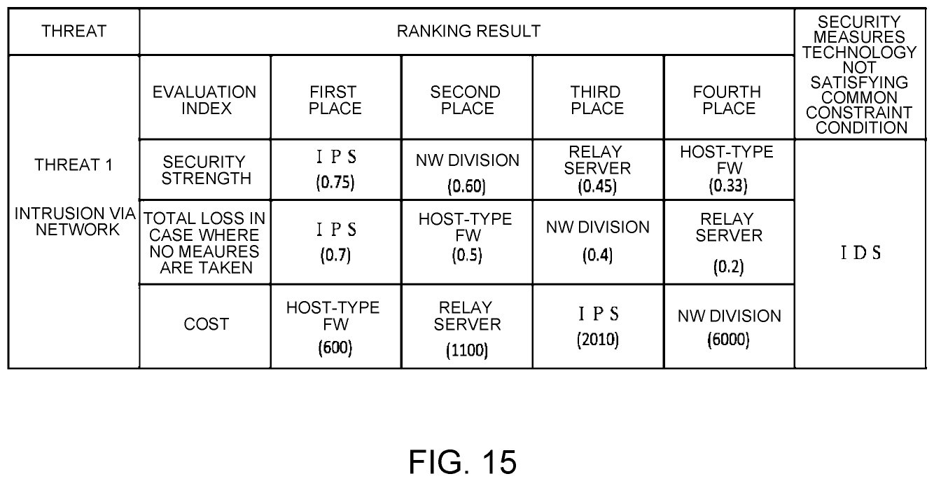

FIG. 15 is a table showing an example of the measures technology set information related to Threat 1. FIG. 15 shows the ranking results of security measures technologies that are effective against Threat 1 and satisfy the common constraint condition, when each of the security strength, the total loss in the case where no measures are taken, and the cost is used as the evaluation index. In addition, in FIG. 15, the “IDS” is shown as a security measures technology that is effective against Threat 1 and does not satisfy the common constraint condition.

In step S527 of FIG. 2, the calculation output unit 1075 outputs the generated measures technology set information to the technology set management unit 108, and the technology set management unit 108 obtains the measures technology set information. The technology set management unit 108 has a function of managing the measures technology set information. There is a plurality of threats in a target system in many cases, and the technology set management unit 108 manages a plurality of measures technology sets (against the plurality of threats). The technology set management unit 108 holds the measures technology sets until the measures technology sets related to all the threats in the target system are obtained. In step S527, a measures technology set to be managed by the technology set management unit 108 is added.

Then, the processing returns to the determination in step S511 in FIG. 2 again. Since Threat 2: “malware infection” among threats in the threat list information in the target system is unprocessed, the processing proceeds to step S513 (step S511: YES). In step S513, the threat-handling information extraction unit 1071 obtains Threat 2: “malware infection” and the threat measures information.

The information processing device 10 performs the processing in steps S513 to S527 by the above-described method.

The security measures technologies that are effective against Threat 2 are the “anti-virus software” and the “host-type FW” based on the threat measures information in FIG. 3. Here, in step S519, when it is determined whether the “anti-virus software” and the “host-type FW” satisfy the common constraint condition based on the threat-handling measures information related to Threat 2 (not shown in FIG. 8), the influence information (FIG. 4) and the requirements information (FIG. 6), all the security measures technology satisfy the common constraint condition, and there is no security measures technology not satisfying the common constraint condition. In this case, there is no list of security measures technologies not satisfying the common constraint condition, and thus, the evaluation value determination unit 1073 does not output the list to the calculation output unit 1075 in step S521.

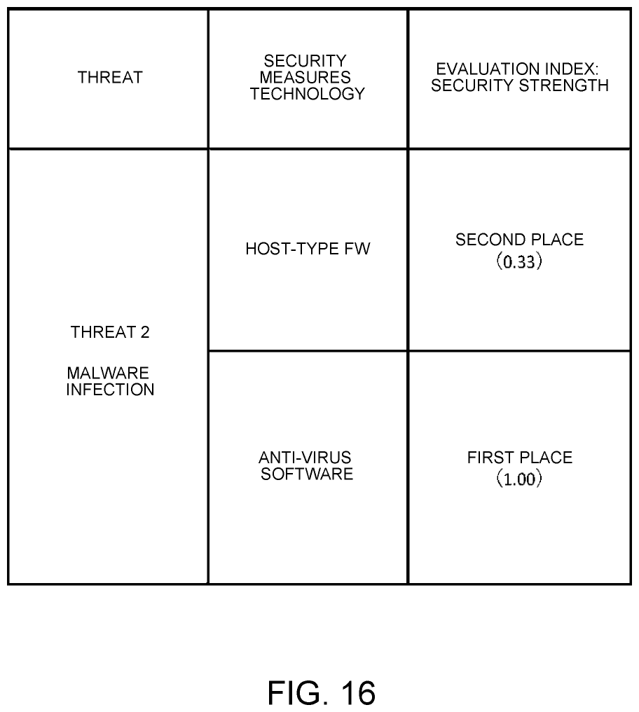

FIGS. 16 to 18 show ranking results of security measures technologies (to be ranked) by the algorithm calculation unit 1074.

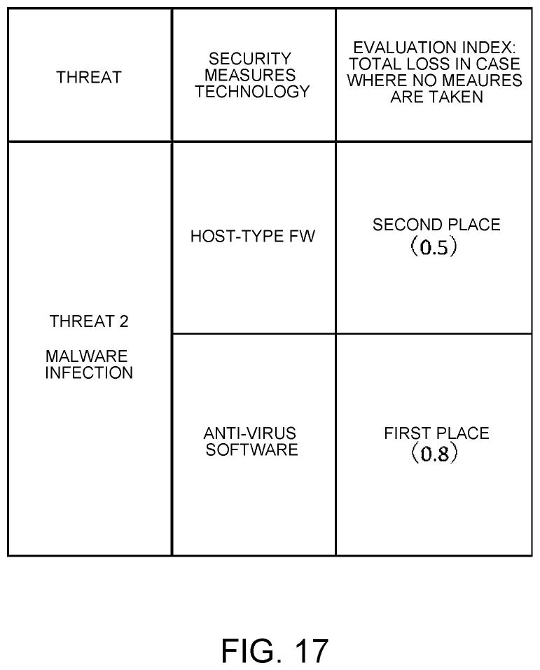

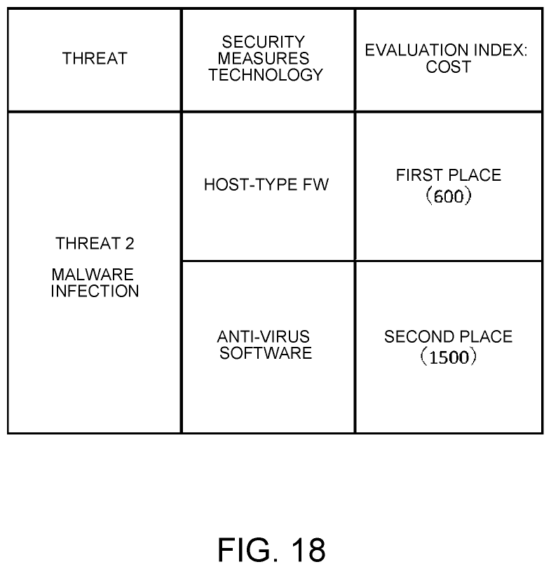

FIG. 16 is a table showing an example of the ranking result by the algorithm calculation unit 1074a. FIG. 17 is a table showing an example of the ranking result by the algorithm calculation unit 1074b. FIG. 18 is a table showing an example of the ranking result by the algorithm calculation unit 1074c.

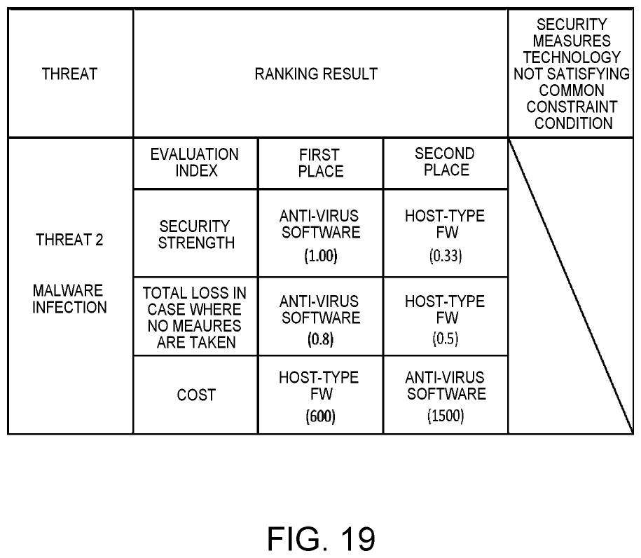

In step S525, the calculation output unit 1075 generates measures technology set information related to Threat 2. FIG. 19 is a table showing an example of the measures technology set related to Threat 2.

FIG. 19 shows the ranking results of security measures technologies that are effective against Threat 2 and satisfy the common constraint condition, when each of the security strength, the total loss in the case where no measures are taken, and the cost is used as the evaluation index. In addition, FIG. 19 shows that there is no security measures technology that is effective against Threat 2 and does not satisfy the common constraint condition.

When the calculation output unit 1075 outputs the measures technology set information related to Threat 2 to the technology set management unit 108 in step S527 of FIG. 2, each of security measures technologies capable of coping with each threat is ranked for all threats in the threat list information, so that there is no unprocessed threat.

Therefore, the threat information obtaining unit 105 determines that there is no unprocessed threat in the threat list information in the determination of step S511 of FIG. 2, and the information processing device 10 proceeds to step S529 (step S511: NO).

In step S529, the technology set management unit 108 outputs the measures technology set information related to each threat in the threat list information to the technology set output unit 109.

In the present embodiment, the technology set management unit 108 outputs the measures technology set information related to Threat 1 and the measures technology set information related to Threat 2 to the technology set output unit 109.

In step S531, the technology set output unit 109 outputs the measures technology set information related to each threat in the threat list information to the display unit 111, and the information processing device 10 ends the processing.

Note that the measures technology set information is displayed on the display unit 111 to be presented to the user. In addition, in a case where the information processing device 10 does not include the display unit 111, the technology set output unit 109 may output information indicating a final measures technology set to a display unit outside the information processing device 10, and the display unit may display the final measures technology set.

The information processing device 10 according to the first embodiment subjects the security measures technology, which satisfies the common constraint condition including at least the system requirements of the target system, to ranking. The information processing device 10 ranks the security measures technologies by calculating ranking for each evaluation index, based on each evaluation value of the security measures technology to be ranked. Further, the information processing device 10 presents the measures technology set information including a ranking for each evaluation index to the user.

As a result, the user can recognize the ranking of the security measures technology for each evaluation index, such as the security strength and the cost, for the security measures technology satisfying at least the common constraint condition by browsing the measures technology set information. That is, the accuracy of the security design of the user is improved. Therefore, the information processing device 10 can support the security design of the user.

### Second Embodiment

In a second embodiment, the same components as those in the first embodiment are denoted by the same reference signs as those in the first embodiment, and a detailed description thereof will be omitted.

The information processing device 10 according to the first embodiment outputs the measures technology set information including the ranking result of the security measures technology for each evaluation index. On the other hand, an information processing device 20 according to the second embodiment re-evaluates the security measures technology, based on results of ranking according to a plurality of evaluation indexes.

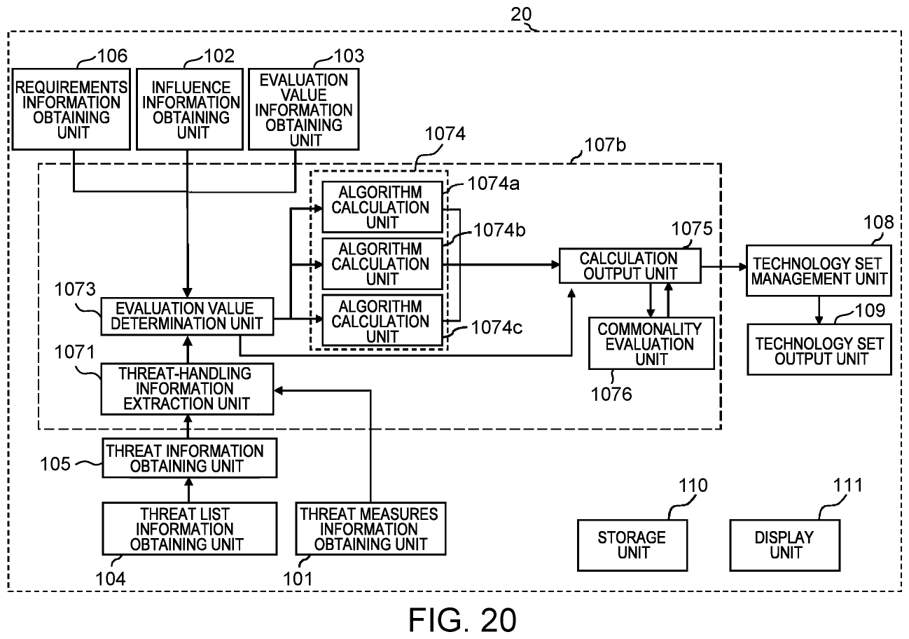

FIG. 20 is a functional block diagram showing an example of a functional configuration of the information processing device 20 according to the second embodiment. As shown in FIG. 20, the information processing device 20 includes a ranking unit 107b, instead of the ranking unit 107 of the information processing device 10. The ranking unit 107b includes a commonality evaluation unit 1076 in addition to the configuration of the ranking unit 107.

The commonality evaluation unit 1076 obtains measures technology set information from the calculation output unit 1075. Further, the commonality evaluation unit 1076 comprehensively evaluates the security measures technology, based on results of ranking according to the plurality of evaluation indexes.

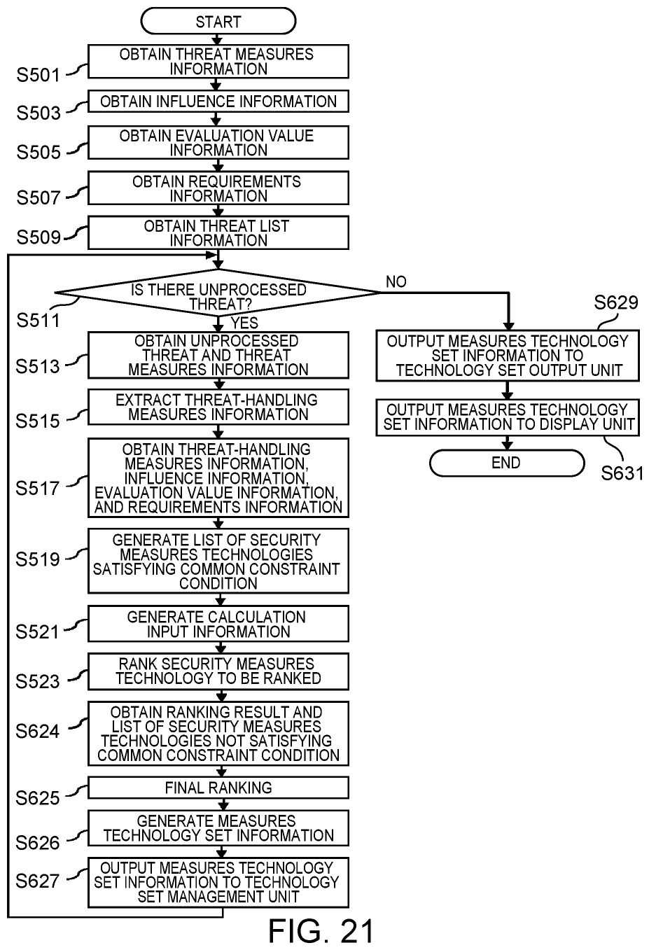

FIG. 21 is a flowchart showing an example of processing executed by the information processing device 20 according to the second embodiment.

In FIG. 21, steps S501 to S523 are the same as the processing of the information processing device 10 according to the first embodiment of FIG. 2, and thus a detailed description thereof will be omitted.

In step S624 of FIG. 21, the calculation output unit 1075 obtains a list of security measures technologies not satisfying a common constraint condition from the evaluation value determination unit 1073, and obtains ranking results from the algorithm calculation unit 1074 (1074a, 1074b, and 1074c).

Here, one shown in FIG. 10 is assumed as the list of security measures technologies not satisfying the common constraint condition similarly to the first embodiment.

In addition, those shown in FIGS. 12, 13 and 14 respectively, are assumed as the ranking results obtained from the algorithm calculation unit 1074 (1074a, 1074b, and 1074c).

Similarly, in step S624, the calculation output unit 1075 outputs the ranking results to the commonality evaluation unit 1076.

In step S625 of FIG. 21, the commonality evaluation unit 1076 obtains the ranking results, and performs the final ranking based on the ranking results.

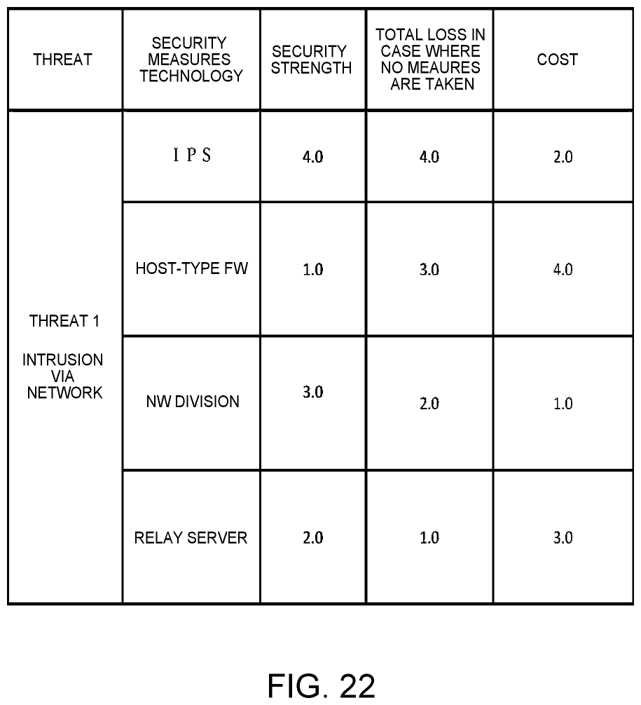

As an example, the commonality evaluation unit 1076 replaces each ranking in the ranking results with a score. In this case, in the ranking results based on the respective evaluation indexes in FIGS. 12, 13 and 14, for example, the commonality evaluation unit 1076 sets a score of the first ranking to 4.0, a score of the second ranking to 3.0, a score of the third ranking to 2.0, and a score of the fourth ranking to 1.0. Such a result is shown in FIG. 22.

The commonality evaluation unit 1076 calculates a sum of scores in each evaluation index as a total score for each security measures technology, and ranks the total scores in descending order.

A total score of “IPS” is 4.0+4.0+2.0=10.0.

A total score of “host-type FW” is 1.0+3.0+4.0=8.0.

A total score of “NW division” is 3.0+2.0+1.0=6.0.

A total score of “relay server” is 2.0+1.0+3.0=6.0.

Therefore, when the ranking is performed in descending order of the total score, the “IPS” becomes the first place, the “host-type FW” becomes the second place, and the “NW division” and the “relay server” become the third place.

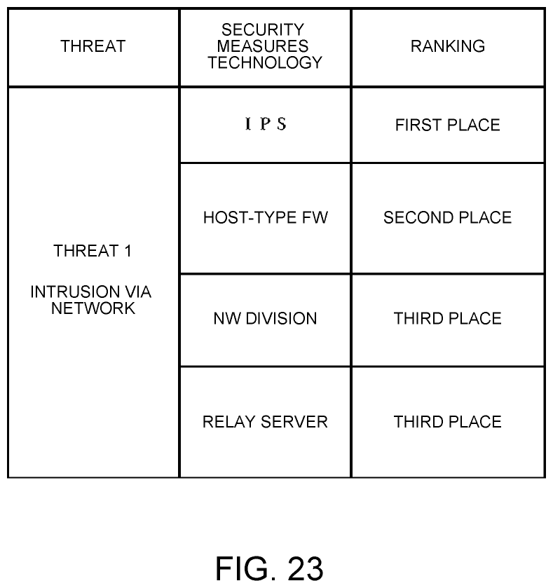

The above final ranking result is shown in FIG. 23.

Similarly, in step S625, the commonality evaluation unit 1073 outputs the final ranking result (FIG. 23) to the calculation output unit 1075.

Note that the above-described final ranking method is an example, it is also possible to perform weighting of evaluation for each evaluation index by the user's inputting the degree of importance for each evaluation index to the requirements information.

In step S626 of FIG. 21, the calculation output unit 1075 obtains the final ranking result, and generates a measures technology set, based on the final ranking result (FIG. 23) and the list of security measures technologies not satisfying the common constraint condition (FIG. 10).

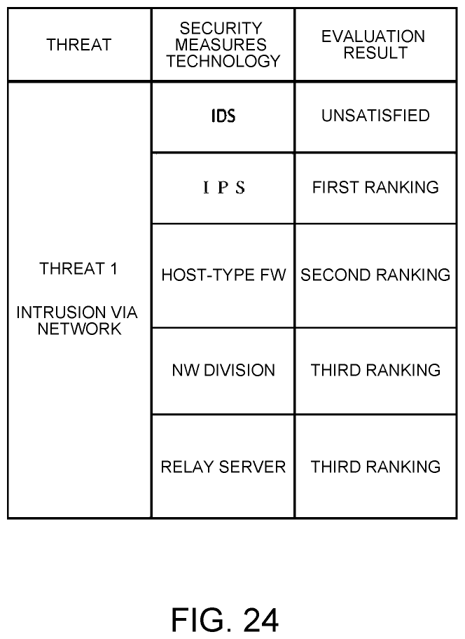

As an example, the calculation output unit 1075 generates the measures technology set information shown in FIG. 24. In FIG. 24, the “IDS” is shown as the security measures technology not satisfying the common constraint condition regarding the security measures technology effective against Threat 1 of “entry via network”. In addition, FIG. 24 shows that the “IPS” is in the first place, the “host-type FW” is in the second place, and the “NW division” and the “relay server” are in the third place, as the final ranking result of the security measures technologies satisfying the common constraint condition regarding the security measures technology effective against Threat 1 of “entry via network”.

In step S627 of FIG. 21, the calculation output unit 1075 outputs the generated measures technology set information to the technology set management unit 108.

In step S629 of FIG. 21, the technology set management unit 108 outputs the measures technology set information to the technology set output unit 109.

In step S631 of FIG. 21, the technology set output unit 109 outputs the measures technology set information to the display unit 111, and the information processing device 20 ends the processing.

As described above, the information processing device 20 according to the second embodiment performs the final ranking from the ranking results of the algorithm calculation units 1074a, 1074b, and 1074c. Then, in regard to the security measures technology effective against the threat, the measures technology set including one ranking result obtained by the final ranking is output.

As a result, the user can recognize the ranking of the security measures technologies comprehensively evaluated from the plurality of ranking results according to the plurality of evaluation indexes. That is, the information processing device 20 according to the second embodiment can further support a security design of the user.

### Third Embodiment

In a third embodiment, the same components as those in the first embodiment are denoted by the same reference signs as those in the first embodiment, and a detailed description thereof will be omitted.

A remaining threat in the specification will be described. The remaining threat is a threat remaining in a target system or a threat newly generated with respect to an asset generated in the target system when a security measures technology has been introduced into cope with a threat of the target system. That is, the remaining threat is the threat remaining in the target system when the security measures technology effective against the threat of the target system has been introduced.

As an example, it is assumed that a security measures technology to be introduced can cope with a part of a threat but is not capable of coping with the other part of the thread. In this case, the other part of the threat that is hardly handled by the security measures technology becomes a remaining threat. As a specific example, it is assumed that a “host-type FW” is introduced as a security measures technology against a threat of “malware infection” of a target system. In this case, the target system can reduce the risk of infection with malware when the malware is downloaded from an unauthorized site via a network, but is not capable of reducing the risk of infection with malware via external media such as a USB memory. Therefore, “malware infection via external media” becomes a remaining threat.

As another example, a case where a threat of a target system can be handled by introducing a security measures technology is considered. In this case, the introduced security measures technology becomes a new asset in the target system, and an attack invalidating the introduced security measures technology becomes a remaining threat. As a specific example, it is assumed that a “host-type FW” as a security measures technology is introduced into a target system against a threat of “malware infection”. In this case, an attack of invalidating the host-type FW by an unauthorized change of the setting of a PC becomes a remaining threat. Therefore, “setting tampering” becomes the remaining threat.

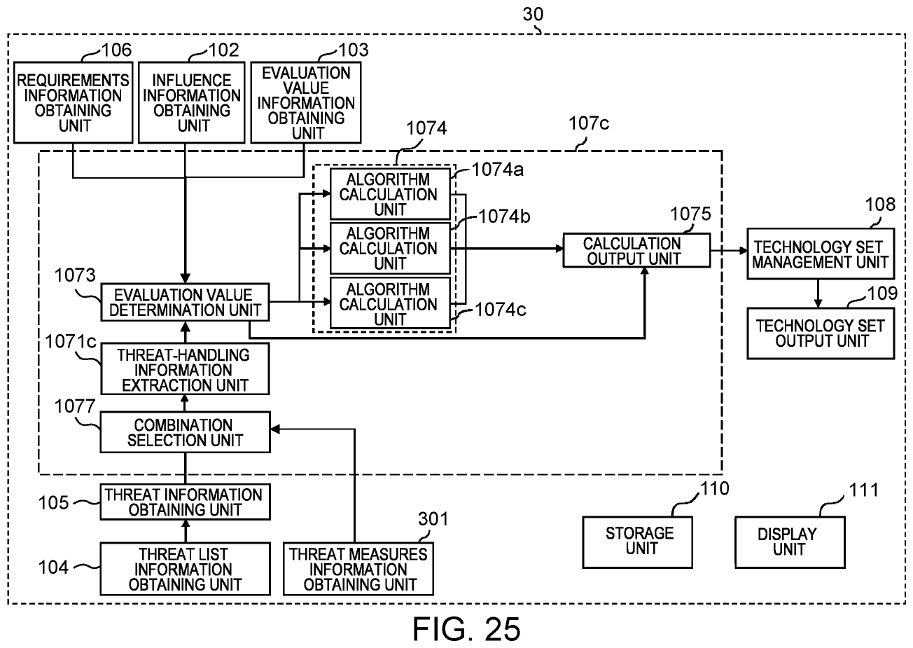

An information processing device 30 according to the third embodiment includes a threat measures information obtaining unit 301 and a ranking unit 107c as shown in FIG. 25 in order to take a security measures even against the remaining threat described above. The ranking unit 107c is different in terms of including a threat-handling information extraction unit 1071c, instead of the threat-handling information extraction unit 1071 of the ranking unit 107 of the information processing device 10 according to the first embodiment, and newly including a combination selection unit 1077.

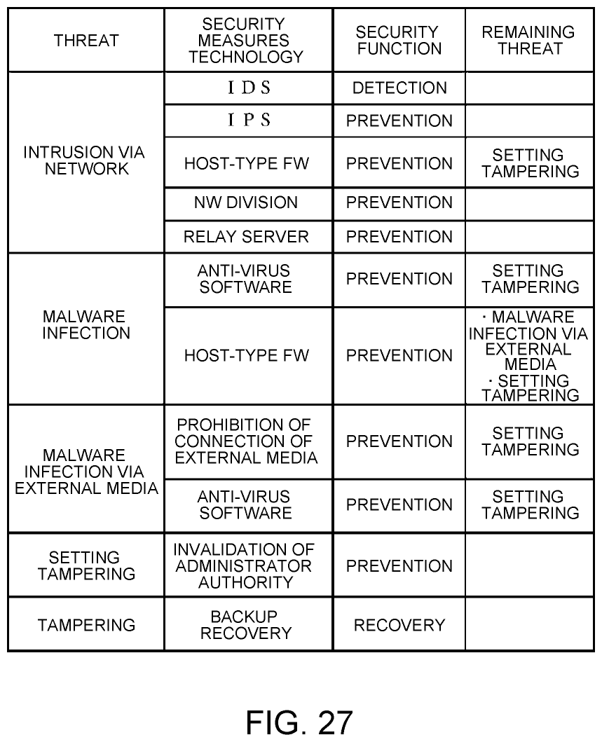

The threat measures information obtaining unit 301 obtains threat measures information including information indicating a remaining threat from, for example, the storage unit 110, and manages the obtained threat measures information in a table format shown in FIG. 27. The threat measures information obtaining unit 301 outputs the threat measures information to the combination selection unit 1077.

The threat information obtaining unit 105 obtains one threat of a target system from the threat list information obtaining unit 104, and outputs the threat information to the combination selection unit 1077.

The combination selection unit 1077 selects a combination including one or more security measures technologies (which will be simply referred to as the combination of security measures technologies hereinafter) that eliminate a threat indicated by the obtained threat information and a remaining threat. The combination selection unit 1077 generates information (which will be referred to as combination information hereinafter) in which the threat information is associated with information indicating the combination.

The combination selection unit (also referred to as combination information generation unit) 1077 outputs the threat measures information to the threat-handling information extraction unit 1071c in addition to the generated combination information. Note that the combination selection unit 1077 may also be referred to as a combination creation unit 1077.

The threat-handling information extraction unit 1071c extracts a security measures technology included in the combination information and a security function associated with the security measures technology as threat-handling measures information. Further, the threat-handling information extraction unit 1071c outputs the extracted threat-handling measures information and the threat information to the evaluation value determination unit 1073.

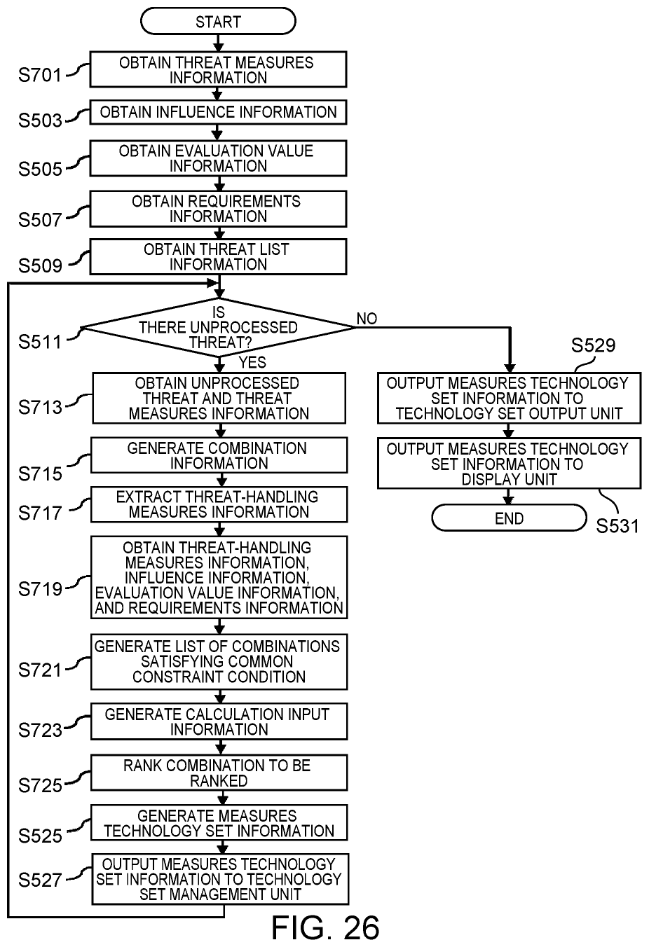

Processing executed by the information processing device 30 according to the third embodiment will be described with reference to the flowchart of FIG. 26.

In step S701 of FIG. 26, the threat measures information obtaining unit 301 obtains threat measures information from the storage unit 110.

FIG. 27 shows an example of the threat measures information managed by the threat measures information obtaining unit 301. The threat measures information shown in FIG. 27 includes a remaining threat in addition to a threat, a security measures technology, and a security function.

FIG. 27 shows that anti-virus software and a host-type FW are present as security measures technologies effective against a threat: “malware infection”. Here, remaining threats of the host-type FW are a remaining thread: “malware infection via external media” and a remaining thread: “setting tampering”.

Since steps S503 to S511 are the same as those in the first embodiment, a detailed description thereof will be omitted.

In step S713 of FIG. 26, the combination selection unit 1077 obtains an unprocessed threat and the threat measures information.

In step S715 of FIG. 26, the combination selection unit 1077 generates combination information indicating a security measures technology that is effective against a threat (indicated by the threat information) and eliminates a remaining threat, based on the threat information related to the unprocessed threat and the threat measures information.

Next, Rules 1, 2, and 3 of the processing of the combination selection unit 1077 in step S715 will be described.

(Rule 1) In a case where there is one remaining threat for one security measures technology, a security measures technology that eliminates the remaining threat is searched for, and this security measures technology is added to a combination of security measures technologies which are effective against the threat and eliminate the remaining threat.

(Rule 2) In a case where there is a plurality of remaining threats for one security measures technology, a combination of security measures technologies that eliminate each of the remaining threats is searched for, and the combination of the security measures technologies is added to the combination of the security measures technologies which are effective against the threat and eliminate the remaining threat. Note that, in a case where the same security measures technology overlaps when the combination of the security measures technologies is added, the combination selection unit 1077 adopts only one security measures technology regarding the overlapping security measures technologies.

(Rule 3) When there is no remaining threat for one security measures technology (blank), a security measures technology that eliminates the remaining threat is not searched for.

In the following description, as an example, a description is given assuming that the threat information obtaining unit 105 obtains a threat: “malware infection” as the threat information in step S713 and outputs the obtained threat information to the combination selection unit 1077, and the combination selection unit 1077 obtains the threat information.

Hereinafter, a method in which the combination selection unit 1077 selects a combination of security measures technologies which are effective against the threat: “malware infection” and eliminate a remaining threat will be described. As described above, there is a plurality of descriptions of “host-type FW” and “anti-virus software” as the security measures technologies effective against the threat: “malware infection”.

When the “host-type FW” is first selected as a first combination, the remaining threat of the “host-type FW” is referred to. From FIG. 27, the remaining threats of the “host-type FW” are the threat: “malware infection via external media” (referred to as Threat A1) and the threat: “configuration tampering” (referred to as Threat A2).

Therefore, as the first combination, a measures technology to be added to the “host-type FW” is selected according to Rule 2. That is, FIG. 27 shows that any one of “prohibition of connection of external media” and “anti-virus software” can be selected as the security measures technology that is effective against Threat A1: “malware infection via external media” and eliminates the remaining threat. Therefore, the first combination is divided into two such that a first combination A is “host-type FW+prohibition of connection of external media+a security measures technology which is effective against setting tampering (A2) and eliminates a remaining threat”, and a first combination B is “host-type FW+anti-virus software+a security measures technology which is effective against setting tampering (A2) and eliminates a remaining threat”.

Referring to FIG. 27, the remaining threat of “prohibition of connection of external media” in the first combination A is “setting tampering”. When referring to FIG. 27 again according to Rule 1, a security measures technology that eliminates the remaining threat: “setting tampering” is “invalidation of administrator authority”, and a field of a remaining threat thereof is blank and thus, Rule 3 is applied.

As described above, the first combination A is “host-type FW+prohibition of connection of external media+invalidation of administrator authority+a security measures technology which is effective against setting tampering (A2) and eliminates a remaining threat”. However, the security measures technology effective against “setting tampering” (A2) is similarly the “invalidation of administrator authority” even when referring to FIG. 27, and thus, the first combination A can be set finally as “host-type FW+prohibition of connection of external media+invalidation of administrator authority” excluding duplication.

Next, a remaining threat of “anti-virus software” in the first combination B is “setting tampering” when referring to FIG. 27. When referring to FIG. 27 again according to Rule 1, a security measures technology that eliminates the remaining threat: “setting tampering” is “invalidation of administrator authority”, and a field of a remaining threat thereof is blank, and thus, Rule 3 is applied. As described above, the first combination B is “host-type FW+anti-virus software+invalidation of administrator authority+a security measures technology which is effective against setting tampering (A2) and eliminates a remaining threat”. Finally, the first combination B can be set as “host-type FW+anti-virus software+invalidation of administrator authority” excluding duplication.

Next, a second combination including “anti-virus software”, which is the second among the security measures technologies effective against the threat: “malware infection”, will be considered. In FIG. 27, the remaining threat of “anti-virus software” is “setting tampering”. Referring again to FIG. 27, the security measures technology effective against the “setting tampering” is “invalidation of administrator authority”, and a remaining threat thereof is blank. Therefore, the second combination can be set as “anti-virus software+invalidation of administrator authority”.

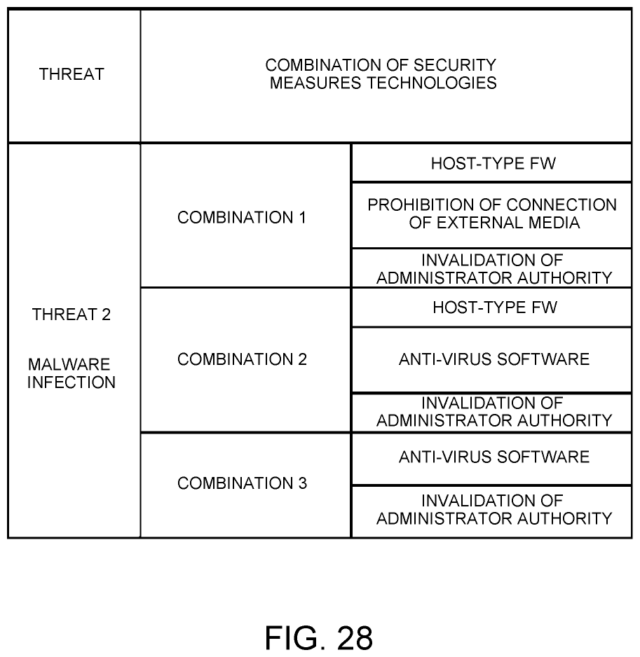

As described above, as the combination of security measures technologies that are effective against the threat: “malware infection” and eliminate the remaining threat, three combinations including the first combination A “host-type FW+prohibition of connection of external media+invalidation of administrator authority”, the first combination B “host-type FW+anti-virus software+invalidation of administrator authority”, and the second combination “anti-virus software+invalidation of administrator authority” can be selected. Hereinafter, the first combination A is referred to as Combination 1, the first combination B is referred to as Combination 2, and the second combination is referred to as Combination 3. Combination information (related to the threat: “malware infection”) including the three combinations obtained in this manner is shown in FIG. 28.

It is shown that each combination included in the combination information of FIG. 28 is the combination that is effective against the threat: “malware infection” and eliminates the remaining threat.

Similarly, in step S715, the combination selection unit 1077 outputs the generated combination information and the threat measures information to the threat-handling information extraction unit 1071c.

In step S717 of FIG. 26, the threat-handling information extraction unit 1071c obtains the combination information and the threat measures information, and extracts threat-handling measures information, based on the combination information and the threat measures information.

Here, the threat-handling measures information in the third embodiment is information in which a threat indicated by threat information, a combination of security measures technologies which are effective against the threat and eliminate a remaining threat, and a security function (one example of security characteristics) of the security measures technologies are associated with each other.

The threat-handling information extraction unit 1071c extracts the security function of the security measures technology included in each combination of the combination information from the threat measures information, and adds the security function to the combination information to generate the threat-handling measures information.

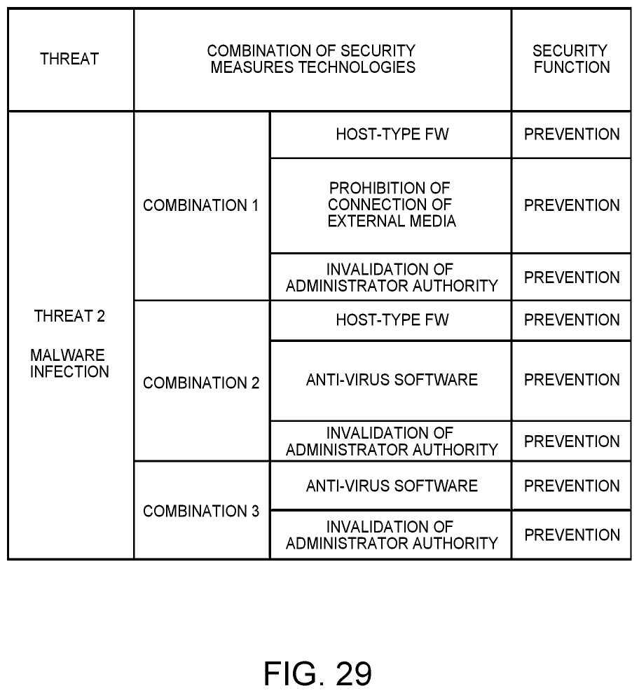

FIG. 29 is a table showing an example of the threat-handling measures information related to the threat: “malware infection” in the third embodiment.

In FIG. 29, Combinations 1 to 3 of security measures technologies which are effective against the threat: “malware” and eliminate the remaining threat are associated with a security function (one example of security characteristics) of the security measures technologies.

For example, it is shown that the security functions of “host-type FW”, “prohibition of connection of external media” and “invalidation of administrator authority” included in Combination 1 are “prevention”.

Similarly, in step S717 of FIG. 26, the threat-handling information extraction unit 1071c outputs the threat-handling measures information to the evaluation value determination unit 1073.

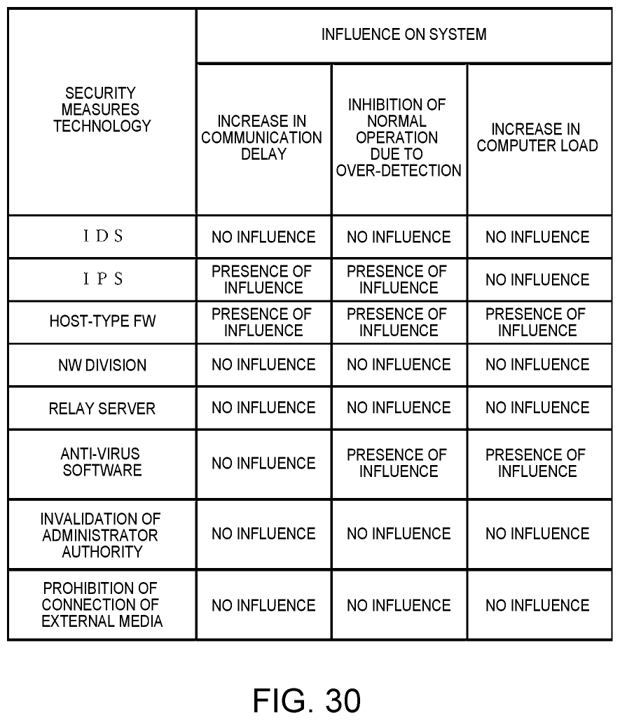

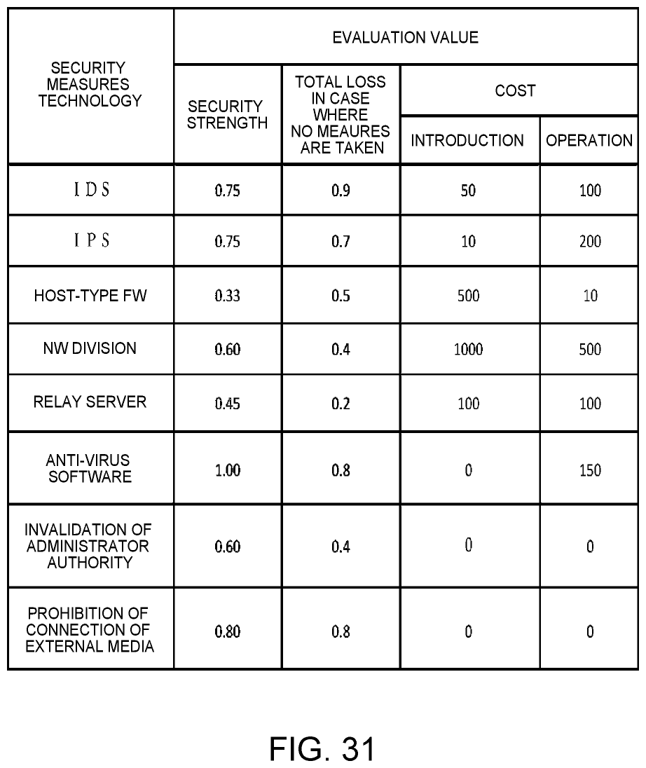

In step S719 of FIG. 26, the evaluation value determination unit 1073 obtains the threat-handling measures information (FIG. 29) related to the threat: “malware infection” from the threat-handling information extraction unit 1071c, obtains influence information (FIG. 30) from the influence information obtaining unit 102, obtains evaluation value information (FIG. 31) from the evaluation value information obtaining unit 103, and obtains the requirements information (FIG. 6) from the requirements information obtaining unit 106.

Here, FIG. 30 is a table showing an example of the influence information according to the third embodiment.

In addition, FIG. 31 is a table showing an example of the evaluation value information according to the third embodiment.

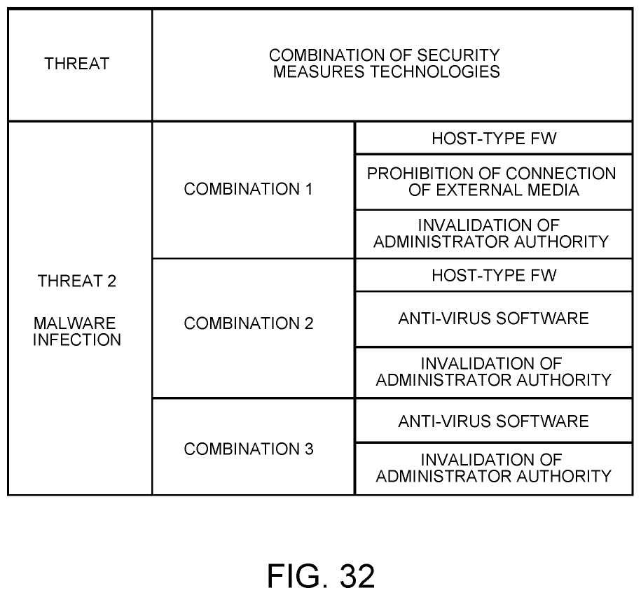

In step S721 of FIG. 26, the evaluation value determination unit 1073 determines whether a common constraint condition is satisfied for a combination included in the threat-handling measures information based on the threat-handling measures information, the influence information and the common constraint condition, and generates a combination list (FIG. 32) satisfying the common constraint condition.

As an example, in a case where each of security measures technologies included in one combination satisfies all of security requirements and system requirements included in the common constraint condition, the evaluation value determination unit 1073 determines that the one combination satisfies the common constraint condition. Here, a method for determining whether or not each of the security measures technologies satisfies the common constraint condition is the same as that of the first embodiment, and thus, a description thereof will be omitted.

In a case where the threat-handling measures information of FIG. 29, the influence information of FIG. 30 and the requirements information of FIG. 6 are used, all the security measures technologies included in each combination of Combination 1, Combination 2 and Combination 3 satisfy the common constraint condition, and thus, Combination 1, Combination 2 and Combination 3 are combinations satisfying the common constraint condition.

FIG. 32 is a table showing an example of security measures technologies satisfying the common constraint condition. In FIG. 32, Combination 1, Combination 2 and Combination 3 are shown as the combinations satisfying the common constraint condition.

Note that, in a case where there is a combination that does not satisfy the common constraint condition in step S721, the evaluation value determination unit 1073 generates a list of combinations not satisfying the common constraint condition.

In addition, in a case where there is no combination satisfying the common constraint condition, such a fact may be output to prompt a user to review the constraint condition.

In step S723 of FIG. 26, the evaluation value determination unit 1073 generates calculation input information to be input to the algorithm calculation unit 1074, based on a list (FIG. 32) of combinations satisfying the common constraint condition and the evaluation value information (FIG. 31).

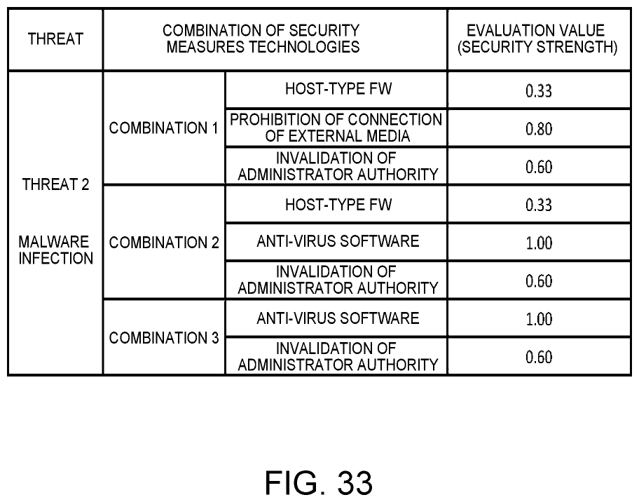

FIGS. 33, 34, and 35 are tables showing examples of the calculation input information according to the third embodiment.

The evaluation value determination unit 1073 extracts an evaluation value corresponding to a security measures technology included in each combination in the list (FIG. 32) of combinations satisfying the common constraint condition from the evaluation value information (FIG. 31), and generates the calculation input information.

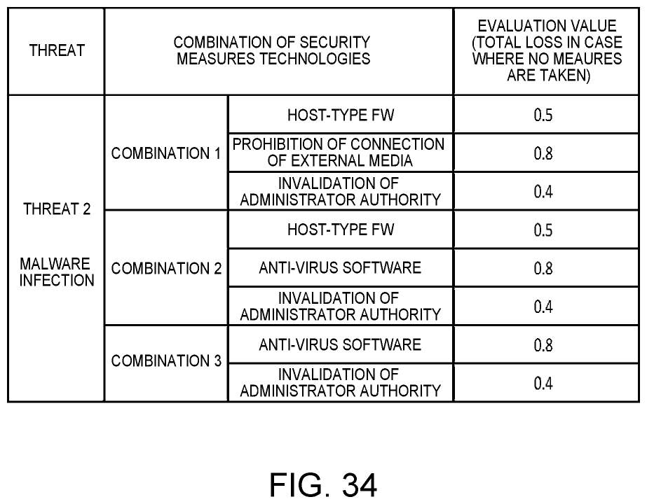

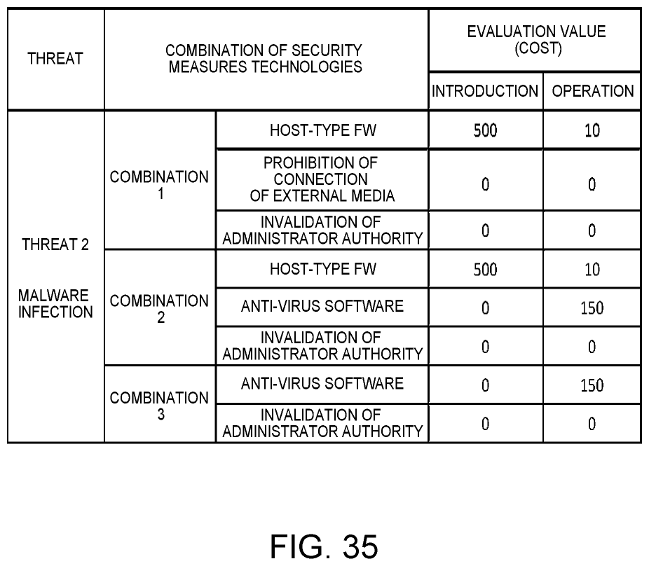

FIG. 33 shows the calculation input information in which security strength is used as an evaluation value and which is input to the algorithm calculation unit 1074a. FIG. 34 shows the calculation input information in which a total loss in a case where no measures are taken is used as an evaluation value and which is input to the algorithm calculation unit 1074b. FIG. 35 is calculation input information in which an introduction cost and an operation cost are used as evaluation values and which is input to the algorithm calculation unit 1074c.

Similarly, in step S723, the evaluation value determination unit 1073 outputs the calculation input information to the algorithm calculation units 1074a, 1074b and 1074c.

In step S725, the algorithm calculation unit 1074 obtains the calculation input information, and ranks a combination to be ranked, based on the calculation input information.

Here, in the third embodiment, the algorithm calculation unit 1074 calculates evaluation indexes of each security measures technology included in the combination to be ranked based on evaluation values, and performs ranking by using a sum of the evaluation indexes of the respective security measures technologies as an evaluation index of the combination to be ranked.

The algorithm calculation unit 1074a ranks the combinations to be ranked by setting the evaluation index to the security strength similarly to the first embodiment. In this case, the evaluation index is the same as the evaluation value associated with the security measures technology.

Referring to FIG. 33, the security strength of the “host-type FW” of Combination 1 is “0.33”, the security strength of the “prohibition of connection of external media” is “0.80”, and the security strength of the “invalidation of administrator authority” is “0.60”.

The sum of the security strengths of the respective security measures technologies is “0.33+0.80+0.60=1.73”.

Therefore, the security strength of Combination 1 is “1.73”. Similarly, the security strength of Combination 2 is “1.90”, and the security strength of Combination 3 is “1.60”.

Accordingly, when the ranking is performed in descending order of the security strength, “Combination 2” becomes the first place, “Combination 1” becomes the second place, and “Combination 3” becomes the third place.

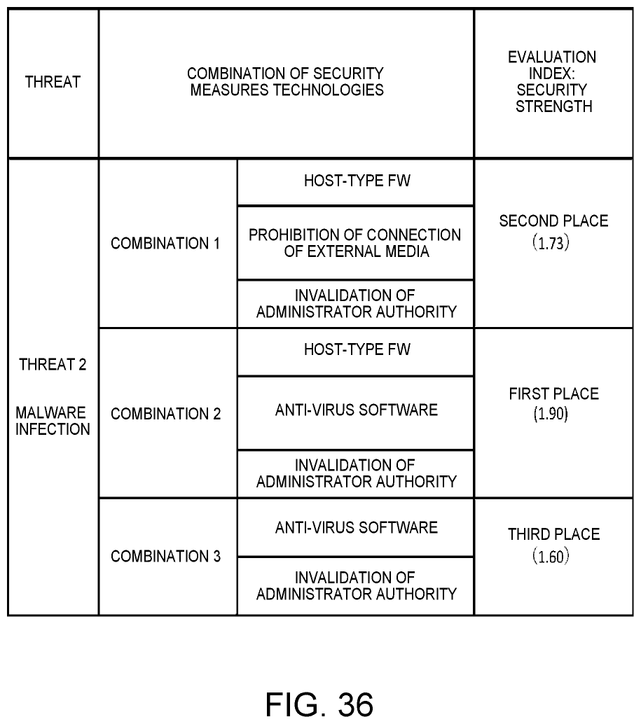

The above result is shown in FIG. 36. FIG. 36 is a table showing an example of the ranking result of the algorithm calculation unit 1074a. As an example, the algorithm calculation unit 1074a generates the ranking result shown in FIG. 36.

In FIG. 36, a combination that is effective against Threat 2, eliminates a remaining threat and satisfies the common constraint condition, the ranking by the algorithm calculation unit 1074a, and a score of the security strength are associated with each other.

Similarly to the first embodiment, by setting the evaluation index to the total loss in a case where no measures are taken, the algorithm calculation unit 1074b ranks a combination to be ranked in descending order of the total loss in the case where no measures are taken. In this case, the evaluation index is the same as the evaluation value associated with the security measures technology.

Referring to FIG. 34, the total losses in the case where no measures are taken of the “host-type FW”, the “prohibition of connection of external media” and the “invalidation of administrator authority” in Combination 1 are “0.5”, “0.8”, and “0.4”, respectively.

A sum of the total losses in the case where no measures of each security measures technology are taken is “0.5+0.8+0.4=1.7”.

Therefore, the total loss when the measures of Combination 1 are not taken is “1.7”. Similarly, the total losses when the measures of Combination 2 and Combination 3 are not taken are “1.7” and “1.2”, respectively.

Accordingly, when ranking is performed in descending order of the total loss in the case where no measures are taken, “Combination 1” and “Combination 2” become the first place, and “Combination 3” becomes the third place.

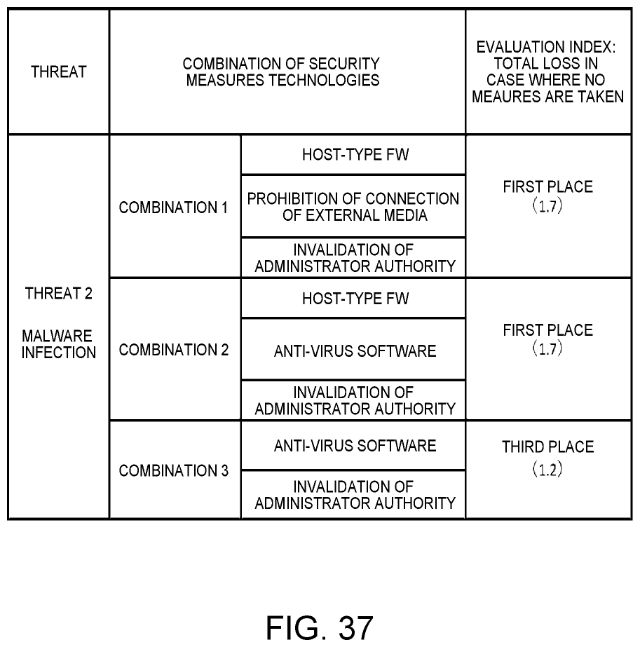

The above result is shown in FIG. 37. FIG. 37 is a table showing an example of the ranking result of the algorithm calculation unit 1074b. As an example, the algorithm calculation unit 1074b generates the ranking result shown in FIG. 37.

In FIG. 37, a combination that is effective against Threat 2, eliminates a remaining threat and satisfies the common constraint condition, the ranking by the algorithm calculation unit 1074b, and a score of the total loss in the case where no measures are taken are associated with each other.

Similarly to the first embodiment, the algorithm calculation unit 1074c ranks the combination to be ranked by setting the evaluation index to the cost. In this case, the evaluation index is a sum of the introduction cost and the operation cost.

Referring to FIG. 35, the introduction cost and the operation cost of the “host-type FW” in Combination 1 are “500” and “10” respectively, the introduction cost and the operation cost of the “prohibition of connection of external media” are “0” and “0” respectively, and the introduction cost and the operation cost of the “invalidation of administrator authority” are “0” and “0” respectively.

The cost of the “host-type FW” is “500+10=510”.

The cost of “prohibition of connection of external media” is “0+0=0”.

The cost of “invalidation of administrator authority” is “0+0=0”.

A sum of the costs of the respective security measures technologies is “510+0+0=510”.

Therefore, the cost of Combination 1 is “510”. Similarly, the cost of Combination 2 is “660”, and the cost of Combination 3 is “150”.

Accordingly, when ranking is performed in ascending order of the cost, “Combination 3” becomes the first place, “Combination 1” becomes the second place, and “Combination 2” becomes the third place.

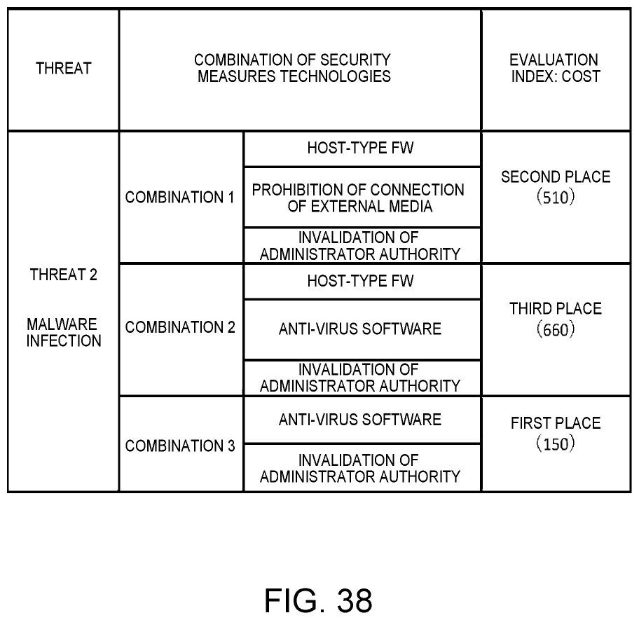

The above result is shown in FIG. 38. FIG. 38 is a table showing an example of the ranking result of the algorithm calculation unit 1074c. As an example, the algorithm calculation unit 1074c generates the ranking result shown in FIG. 38.

In FIG. 38, a combination that is effective against Threat 2, eliminates a remaining threat and satisfies a common constraint condition, the ranking by the algorithm calculation unit 1074c, and a score of the cost are associated with each other.

In step S725 of FIG. 26, the algorithm calculation unit 1074 (1074a, 1074b and 1074c) further outputs calculation output information to the calculation output unit 1075. Steps S525 to S531 in FIG. 26 are the same as those in the first embodiment, and thus, a description thereof is omitted.

The information processing device 30 according to the third embodiment can select combinations of security measures technologies capable of eliminating the threat and the remaining threat of the target system. In addition, among these combinations, the information processing device 30 can rank combinations satisfying the common constraint condition based on the system requirements, and can present this ranking result to the user.

That is, the information processing device 30 can eliminate the threat and the remaining threat of the target system, and rank the combination satisfying at least the common constraint condition, and thus, can further support a security design of the user.

FIG. 39 is a block diagram showing an example of a hardware configuration of the information processing device 10 according to the first embodiment. The information processing device 20 and the information processing device 30 have similar hardware configurations. The information processing device 10 is, for example, a computer. The information processing device 10 includes, as a hardware configuration, a processor 11, an output unit 12, an input unit 13, a main storage unit 14, an auxiliary storage unit 15, a communication unit 16, and a display unit 17. The processor 11, the output unit 12, the input unit 13, the main storage unit 14, the auxiliary storage unit 15, the communication unit 16, and the display unit 17 are connected to each other via a bus.

The information processing device 10 operates when the processor 11 executes a program read from the auxiliary storage unit 15 to the main storage unit 14. The threat measures information obtaining unit 101, the influence information obtaining unit 102, the requirements information obtaining unit 106, the threat list information obtaining unit 104, the threat information obtaining unit 105, the ranking unit 107, the technology set management unit 108, and the technology set output unit 109 described above are implemented as the processor 11 executes the program.

The processor 11 executes the program read from the auxiliary storage unit 15 to the main storage unit 14. The processor 11 is, for example, a central processing unit (CPU).

The main storage unit 14 is, for example, a memory such as a read only memory (ROM) and a random access memory (RAM).

The auxiliary storage unit 15 is, for example, a hard disk drive (HDD), a solid state drive (SSD), a memory card, or the like.

The output unit 12 is an interface configured to output information indicating a result of processing of the information processing device 10. The output unit 12 is a port to which a display device such as an external display (not shown) is connected, and is, for example, a universal serial bus (USB) terminal or a high definition multimedia interface (HDMI) (registered trademark) terminal.

The display unit 17 displays display information such as information indicating the processing result of the information processing device 10. The display unit 17 is, for example, a liquid crystal display, or the like.

The input unit 13 is an interface configured to operate the information processing device 10. The user inputs various types of information to the information processing device 10 using the input unit 13. The input unit 13 is, for example, a keyboard, a mouse, or the like. When the computer is a smart device such as a smartphone and a tablet terminal, the output unit 12 and the input unit 13 are configured using a touch panel or the like. The communication unit 16 is an interface configured for communication with an external device.

The communication unit 16 is, for example, a network interface card (NIC).

The program executed by the computer is recorded as a file in an installable format or an executable format in a non-transitory computer readable storage medium such as a CD-ROM, a memory card, a CD-R and a digital versatile disc (DVD), and is provided as a computer program product.

In addition, the program executed by the computer may be stored on a computer connected to a network such as the Internet, and provided by being downloaded via the network.

In addition, the program executed by the computer may be provided via a network such as the Internet, without being downloaded. In addition, the program executed by the computer may be provided by being incorporated into the ROM in advance.

The program executed by the computer has a module configuration including a functional configuration that can also be implemented by the program among the functional configurations (functional blocks) of the information processing device 10. As the respective functional blocks, the processor 11 reads a program from a storage medium and executes the program in actual hardware, so that the above functional blocks are loaded on the main storage unit 14. That is, the functional blocks are generated on the main storage unit 14.

Note that, some or all of the functional blocks described above are not necessarily implemented by software, but may be implemented by hardware such as an integrated circuit (IC). In addition, in a case where the respective functions are implemented by using a plurality of processors, each of the processors may realize one of the functions or may realize two or more of the functions.

In addition, the computer that realizes the information processing device 10 may operate in any mode. For example, the information processing device 10 may be realized by one computer. In addition, the information processing device 10 may be operated as a cloud system on a network.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
processing circuitry configured to operate as:
an influence information obtaining unit configured to obtain influence information indicating a correspondence between one or more security measures technologies and an influence on a system when each of the one or more security measures technologies is introduced into the system;
a requirements information obtaining unit configured to obtain common constraint condition information indicating system requirements of the system; and
a ranking unit configured to classify the one or more security measures technologies into a security measures technology satisfying a common constraint condition indicating the system requirements and a security measures technology not satisfying the common constraint condition, based on the common constraint condition information and the influence information, and to rank the security measures technology satisfying the common constraint condition.

2. The information processing device according to claim 1, wherein
the ranking unit comprises
an evaluation value determination unit configured to classify the one or more security measures technologies into the security measures technology satisfying the common constraint condition and the security measures technology not satisfying the common constraint condition, based on the common constraint condition information and the influence information, and
a calculation unit configured to rank the security measures technology satisfying the common constraint condition.

3. The information processing device according to claim 2, wherein
the processing circuitry further configured to operate as:
an evaluation value information obtaining unit configured to obtain evaluation value information indicating a correspondence between the one or more security measures technologies and an evaluation value of each of the one or more security measures technologies,
wherein
the evaluation value determination unit extracts the evaluation value associated with the security measures technology satisfying the common constraint condition from the evaluation value information, and
the calculation unit ranks the security measures technology satisfying the common constraint condition, based on the evaluation value associated with the security measures technology satisfying the common constraint condition.

4. The information processing device according to claim 3, wherein
the evaluation value includes at least one of a security strength, a cost, and a total loss in a case where the security measures technology is not taken.

5. The information processing device according to claim 1, wherein
the one or more security measures technologies are capable of coping with one threat assumed for the system.

6. The information processing device according to claim 5, wherein
the processing circuitry further configured to operate as:
a threat information obtaining unit configured to obtain threat information indicating the one threat; and
a threat measures information obtaining unit configured to obtain threat measures information indicating a correspondence between the one threat and the one or more security measures technologies capable of coping with the one threat,
wherein the ranking unit determines the one or more security measures technologies, based on the threat measures information and the threat information.

7. The information processing device according to claim 6, wherein
the threat measures information further includes information indicating a correspondence between the one or more security measures technologies and a security characteristic of each of the one or more security measures technologies,
the common constraint condition information further includes security requirements of the system, and
the ranking unit classifies the one or more security measures technologies into a security measures technology satisfying the common constraint condition and a security measures technology not satisfying the common constraint condition, based on the common constraint condition information, the influence information and the threat measures information, and ranks the security measures technology satisfying the common constraint condition.

8. The information processing device according to claim 6, wherein
the ranking unit further generates measures technology set information in which the threat information indicating the one threat, a ranking of security measures technologies satisfying the common constraint condition, and the security measures technology not satisfying the common constraint condition, are associated with each other.

9. The information processing device according to claim 8, wherein
the processing circuitry further configured to operate as:
a threat list information obtaining unit configured to obtain threat list information indicating threats assumed for the system,
wherein the threat information obtaining unit obtains the threat information indicating the one threat from the threat list information.

10. An information processing device comprising:
processing circuitry configured to operate as:
an influence information obtaining unit configured to obtain influence information indicating a correspondence between one or more security measures technologies and an influence on a system when each of the one or more security measures technologies is introduced into the system;
an evaluation value information obtaining unit configured to obtain evaluation value information indicating a correspondence between the one or more security measures technologies, and a first evaluation value and a second evaluation value of each of the one or more security measures technologies;
a requirements information obtaining unit configured to obtain common constraint condition information indicating system requirements of the system; and
a ranking unit comprising
an evaluation value determination unit configured to classify the one or more security measures technologies into a security measures technology satisfying a common constraint condition indicating the system requirements and a security measures technology not satisfying the common constraint condition, based on the common constraint condition information and the influence information, and to extract the first evaluation value and the second evaluation value associated with the security measures technology satisfying the common constraint condition from the evaluation value information,
a calculation unit configured to rank the security measures technology satisfying the common constraint condition as a first ranking, based on the first evaluation value associated with the security measures technology satisfying the common constraint condition, and to rank the security measures technology satisfying the common constraint condition as a second ranking, based on the second evaluation value associated with the security measures technology satisfying the common constraint condition, and
a commonality evaluation unit configured to perform a final ranking of the security measures technology satisfying the common constraint condition, based on the first ranking and the second ranking.

11. The information processing device according to claim 10, wherein
the commonality evaluation unit replaces the first ranking of the security measures technology satisfying the common constraint condition with a first score, replaces the second ranking of the security measures technology satisfying the common constraint condition with a second score, calculates a sum of the first score and the second score of the security measures technology satisfying the common constraint condition as a total score, and performs the final ranking of the security measures technology satisfying the common constraint condition in descending order of the total score.

12. The information processing device according to claim 11, wherein
the commonality evaluation unit replaces the first ranking having a higher place with the first score having a larger value, and replaces the second ranking having a higher place with the second score having a larger value.

13. An information processing device comprising:
processing circuitry configured to operate as:
an influence information obtaining unit configured to obtain influence information indicating a correspondence between security measures technologies forming each combination included in one or more combinations and an influence on a system when each of the security measures technologies included in the combination is introduced into the system;
a requirements information obtaining unit configured to obtain common constraint condition information indicating system requirements of the system; and
a ranking unit configured to classify the one or more combinations into a combination satisfying a common constraint condition indicating the system requirements and a combination not satisfying the common constraint condition, based on the common constraint condition information and the influence information, and to rank the combination satisfying the common constraint condition.

14. The information processing device according to claim 13, wherein
the processing circuitry further configured to operate as:
a threat information obtaining unit configured to obtain threat information indicating one threat assumed for the system; and
a threat measures information obtaining unit configured to obtain threat measures information indicating a correspondence between the one threat and a security measures technology capable of coping with the one threat,
wherein the ranking unit creates information indicating the one or more combinations, based on the threat information and the threat measures information.

15. The information processing device according to claim 14, wherein
the threat measures information indicates a correspondence among the threat information, the security measures technology, and a remaining threat remained in the system when the security measures technology is introduced into the system.

16. The information processing device according to claim 15, wherein
the ranking unit comprises
a combination selection unit configured to select the combination including one or more security measures technologies capable of eliminating the one threat and the remaining thread, based on the threat information and the threat measures information.

17. The information processing device according to claim 16, wherein,
in a case where the thread measures information includes a plurality of remaining threads associated with the one thread and one security measures technology,
the combination selection unit selects the combination including one or more security measures technologies capable of eliminating the one threat and each of the plurality of remaining threads.

18. The information processing device according to claim 16, wherein
the ranking unit comprises
a threat-handling information extraction unit configured to extract threat-handling measures information indicating a correspondence among the threat information, the combination including the one or more security measures technologies, a security characteristic of each security measures technology included in the combination.

19. The information processing device according to claim 18, wherein
the ranking unit comprises
an evaluation value determination unit configured to determine that the combination satisfies the common constraint condition in a case where each security measures technology included in the combination satisfies the common constraint condition, based on the threat-handling measures information, the influence information and the common constraint condition information.

20. A non-transitory computer readable storage medium for causing a computer to perform operations,
the operations comprising:
obtaining influence information indicating a correspondence between one or more security measures technologies and an influence on a system when each of the one or more security measures technologies is introduced into the system;
obtaining common constraint condition information indicating system requirements of the system; and
classifying the one or more security measures technologies into a security measures technology satisfying a common constraint condition indicating the system requirements and a security measures technology not satisfying the common constraint condition, based on the common constraint condition information and the influence information; and
ranking the security measures technology satisfying the common constraint condition.
